(19) United States
(12) Patent Application Publication
(10) Pub. No.: US 2026/0100741 A1
(43) Pub. Date: Apr. 9, 2026

(54) LAYER QUALITY REPORTING

(71) Applicant: Samsung Electronics Co., Ltd., Suwon-si (KR)

(72) Inventors: Md. Saifur Rahman, Plano, TX (US); Eko Onggosanusi, Coppell, TX (US)

(21) Appl. No.: 19/327,932

(22) Filed: Sep. 12, 2025

Related U.S. Application Data
(60) Provisional application No. 63/703,723, filed on Oct. 4, 2024.
(60) Provisional application No. 63/708,539, filed on Oct. 17, 2024.

(51) Int. Cl. H04B 7/06; H04B 17/318

(52) U.S. Cl. CPC H04B 7/0626; H04B 7/0632; H04B 17/328

(57) ABSTRACT

Apparatuses and methods for layer quality reporting. A method performed by a user equipment (UE) includes receiving information about a channel state information (CSI) report, determining, based on the information, a quality of ν layers, where ν≥1, and transmitting the CSI report including an indicator indicating the quality of ν layers. The quality of ν layers corresponds to q=[q₁, . . . , q_{ν}], where a value qₗ is associated with a layer l∈(1, . . . , ν) and qₗ≥0.

### CROSS-REFERENCE TO RELATED AND CLAIM OF PRIORITY

The present application claims priority under 35 U.S.C. § 119(e) to U.S. Provisional Patent Application No. 63/703,723 filed on Oct. 4, 2024 and U.S. Provisional Patent Application No. 63/708,539 filed on Oct. 17, 2024, which are hereby incorporated by reference in their entirety.

### TECHNICAL FIELD

The present disclosure relates generally to wireless communication systems and, more specifically, the present disclosure is related to apparatuses and methods for layer quality reporting.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to layer quality reporting.

In one embodiment, a user equipment (UE) is provided. The UE includes a transceiver configured to receive information about a channel state information (CSI) report and a processor operably coupled to the transceiver. The processor, based on the information, is configured to determine a quality of ν layers, where ν≥1. The transceiver is further configured to transmit the CSI report including an indicator indicating the quality of ν layers. The quality of ν layers corresponds to q=[q₁, . . . , q_{ν}], where a value qₗ is associated with a layer l∈{1, . . . , ν} and qₗ≥0.

In another embodiment, a base station (BS) is provided. The BS includes a processor and a transceiver operably coupled to the processor. The transceiver is configured to transmit information about a CSI report and receive the CSI report including an indicator indicating a quality of ν layers, where ν≥1. The quality of ν layers corresponds to q=[q₁, . . . ,q_{ν}], where a value qₗ is associated with a layer l∈{1, . . . , ν} and qₗ≥0.

In yet another embodiment, a method performed by a UE is provided. The method includes receiving information about a CSI report, determining, based on the information, a quality of ν layers, where ν≥1, and transmitting the CSI report including an indicator indicating the quality of ν layers. The quality of ν layers corresponds to q=[q₁, . . . ,q_{ν}], where a value qₗ is associated with a layer l∈{1, . . . , ν} and qₗ≥0.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates an example of a transmitter structure for physical downlink shared channel (PDSCH) in a subframe according to embodiments of the present disclosure;

FIG. 7 illustrates an example of a receiver structure for PDSCH in a subframe according to embodiments of the present disclosure;

FIG. 8 illustrates an example of a transmitter structure for physical uplink shared channel (PUSCH) in a subframe according to embodiments of the present disclosure;

FIG. 9 illustrates an example of a receiver structure for a PUSCH in a subframe according to embodiments of the present disclosure;

FIG. 10 illustrates example radio access network (RAN) configurations according to embodiments of the present disclosure;

FIG. 11 illustrates a diagram of example functional split points/options according to embodiments of the present disclosure;

FIG. 12 illustrates an example of a fully digital transmitter structure for beamforming according to embodiments of the present disclosure;

FIGS. 13A and 13B illustrate examples of multiple-input-multiple-output (MIMO) transmission systems according to embodiments of the present disclosure;

FIG. 14 illustrates an example multi user (MU)-MIMO configuration according to embodiments of the present disclosure;

FIG. 15 illustrates example pre-coders according to embodiments of the present disclosure;

FIG. 16 illustrates example antenna port layouts according to embodiments of the present disclosure;

FIG. 17 illustrates a timeline of example spatial-domain (SD) units and frequency-domain (FD) units according to embodiments of the present disclosure;

FIG. 18 illustrates an example port group (PG) according to embodiments of the present disclosure;

FIG. 19 illustrates examples of narrow/wide and co-located/non-co-located ports/PGs according to embodiments of the present disclosure;

FIG. 20 illustrates examples of channel measurement configurations according to embodiments of the present disclosure;

FIG. 21 illustrates an example a codebook configuration according to embodiments of the present disclosure;

FIG. 22 illustrates a flowchart of an example UE procedure for determining a report quantity according to embodiments of the present disclosure;

FIG. 23 illustrates a flow diagram of an example procedure for measuring/estimating UL/DL channel(s) according to embodiments of the present disclosure;

FIG. 24 illustrates a signal flow of an example procedure for indicating layer quality according to embodiments of the present disclosure; and

FIG. 25 illustrates an example method performed by a UE in a wireless communication system according to embodiments of the present disclosure.

### DETAILED DESCRIPTION

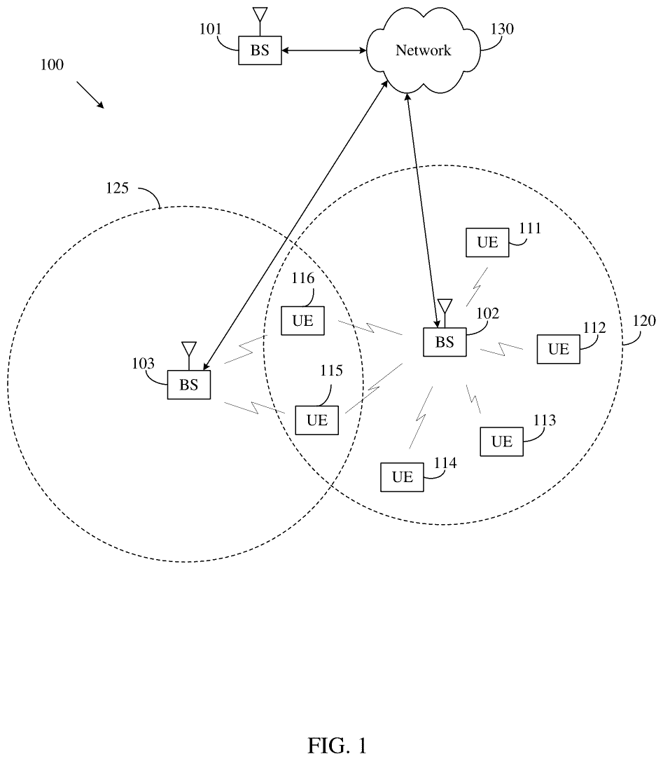

FIGS. 1-25 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive MIMO, full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

In the 5G system, Hybrid frequency shift keying (FSK) and QAM Modulation (FQAM) and sliding window superposition coding (SWSC) as an advanced coding modulation (ACM), and filter bank multi carrier(FBMC), non-orthogonal multiple access(NOMA), and sparse code multiple access (SCMA) as an advanced access technology have been developed.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP TS 36.211 v17.3.0, “E-UTRA, Physical channels and modulation;” [REF 2] 3GPP TS 36.212 v17.1.0, “E-UTRA, Multiplexing and Channel coding;” [REF 3] 3GPP TS 36.213 v17.3.0, “E-UTRA, Physical Layer Procedures;” [REF 4]3GPP TS 36.321 v17.3.0, “E-UTRA, Medium Access Control (MAC) protocol specification;” [REF 5] 3GPP TS 36.331 v17.3.0, “E-UTRA, Radio Resource Control (RRC) Protocol Specification;” [REF 6] 3GPP TR 22.891 v1.2.0; [REF 7] 3GPP TS 38.212 v18.0.0, “E-UTRA, NR, Multiplexing and Channel coding;” [REF 8] 3GPP TS 38.214 v18.0.0, “E-UTRA, NR, Physical layer procedures for data;” [REF 9] 3GPP TS 38.211 v18.0.0, “E-UTRA, NR, Physical channels and modulation;” [REF 10] 3GPP TS 38.104 v18.3.0, “E-UTRA, NR, Physical channels and modulation;” [REF 11] 0-RAN.WG4.CONF.0-R003-v09.00, “O-RAN Working Group 4 (Fronthaul Working Group) Conformance Test Specification;” and [REF 12] O-RAN.WG4.CUS.0-R003-v13.00, “O-RAN Working Group 4 (Open Fronthaul Interfaces WG)—Control, User and Synchronization Plane Specification.

FIGS. 1-24 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof to perform layer quality reporting. In certain embodiments, one or more of the BSs 101-103 include circuitry, programing, or a combination thereof to support layer quality reporting.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

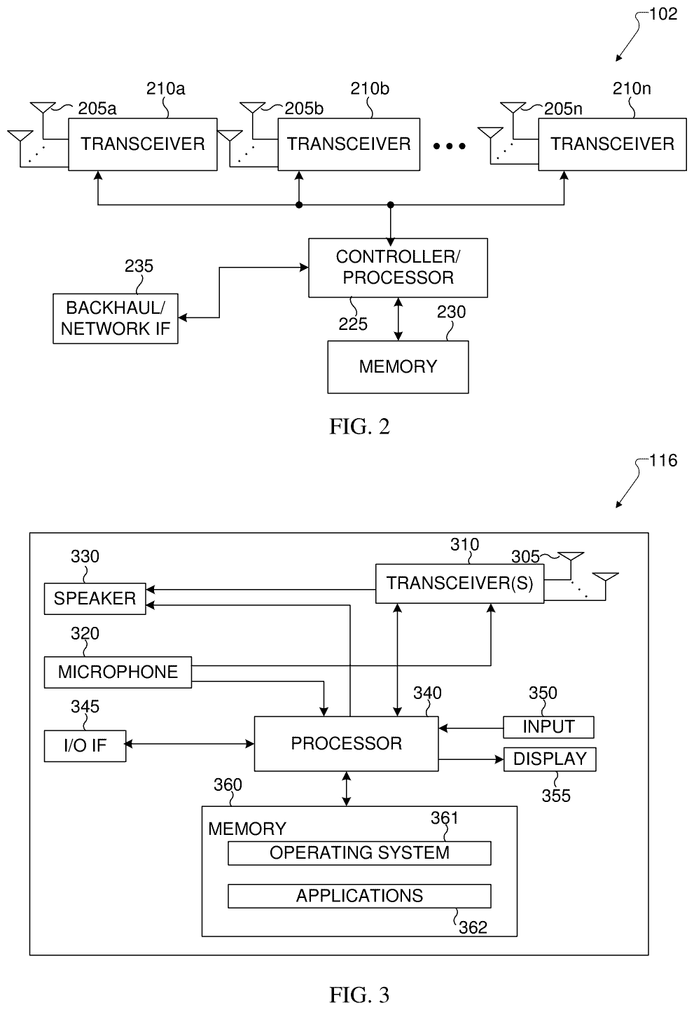

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for layer quality reporting. Any of a wide variety of other functions could be supported in the gNB 102 by the controller/processor 225.

The controller/processor 225 is also capable of executing programs and other processes resident in the memory 230, such as processes to support layer quality reporting. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of uplink (UL) channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for layer quality reporting as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

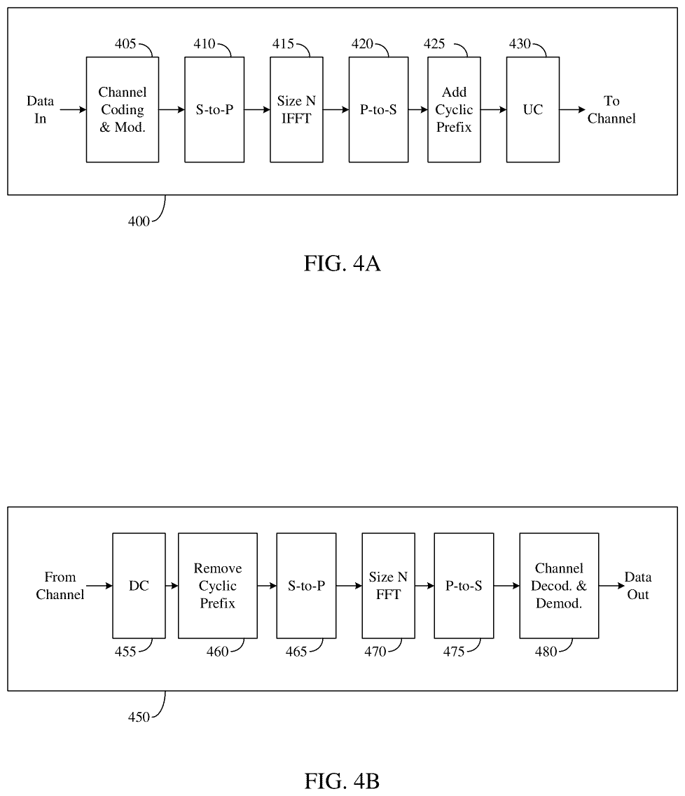

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured for layer quality reporting as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

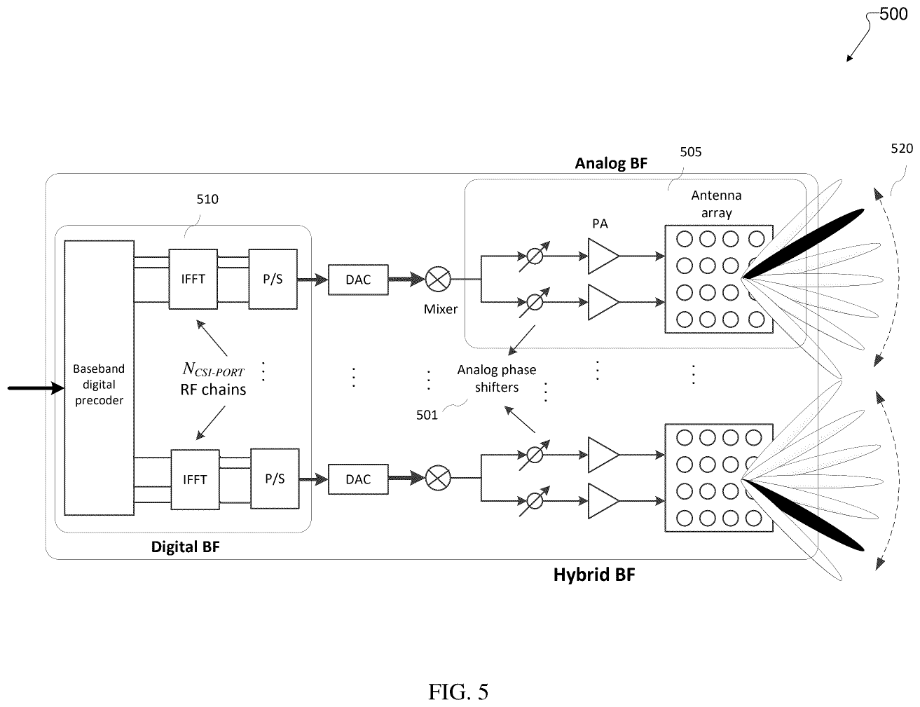

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 channel state indication/information CSI reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are essential to compensate for the additional path loss.

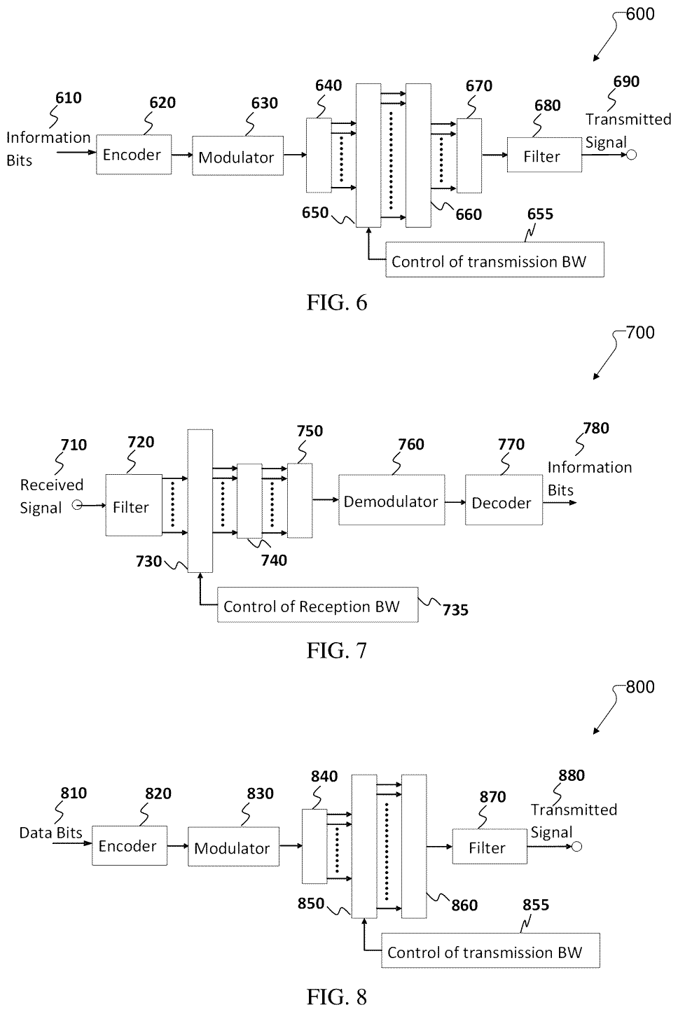

FIG. 6 illustrates an example of a transmitter structure 600 for PDSCH in a subframe according to embodiments of the present disclosure. For example, transmitter structure 600 can be implemented in gNB 102 of FIG. 1. This example is for illustration only and other embodiments can be used without departing from the scope of the present disclosure.

As illustrated in FIG. 6, information bits 610 are encoded by encoder 620, such as a turbo encoder, and modulated by modulator 630, for example using Quadrature Phase Shift Keying (QPSK) modulation. A Serial to Parallel (S/P) converter 640 generates M modulation symbols that are subsequently provided to a mapper 650 to be mapped to REs selected by a transmission BW selection unit 655 for an assigned PDSCH transmission BW, unit 660 applies an Inverse Fast Fourier Transform (IFFT), the output is then serialized by a Parallel to Serial (P/S) converter 670 to create a time domain signal, filtering is applied by filter 680, and a signal transmitted 690. Additional functionalities, such as data scrambling, cyclic prefix insertion, time windowing, interleaving, and others are well known in the art and are not shown for brevity.

FIG. 7 illustrates an example of a receiver structure 700 for PDSCH in a subframe according to embodiments of the present disclosure. For example, receiver structure 700 can be implemented by any of the UEs 111-116 of FIG. 1. This example is for illustration only and other embodiments can be used without departing from the scope of the present disclosure.

With reference to FIG. 7, a received signal 710 is filtered by filter 720, REs 730 for an assigned reception BW are selected by BW selector 735, unit 740 applies a Fast Fourier Transform (FFT), and an output is serialized by a parallel-to-serial converter 750. Subsequently, a demodulator 760 coherently demodulates data symbols by applying a channel estimate obtained from a demodulation reference signal (DMRS) or a CRS (not shown), and a decoder 770, such as a turbo decoder, decodes the demodulated data to provide an estimate of the information data bits 780. Additional functionalities such as time-windowing, cyclic prefix removal, de-scrambling, channel estimation, and de-interleaving are not shown for brevity.

FIG. 8 illustrates an example of a transmitter structure 800 for PUSCH in a subframe according to embodiments of the present disclosure. For example, transmitter structure 800 can be implemented in gNB 103 of FIG. 1. This example is for illustration only and other embodiments can be used without departing from the scope of the present disclosure.

As illustrated in FIG. 8, information data bits 810 are encoded by encoder 820, such as a turbo encoder, and modulated by modulator 830. A Discrete Fourier Transform (DFT) unit 840 applies a DFT on the modulated data bits, REs 850 corresponding to an assigned PUSCH transmission BW are selected by transmission BW selection unit 855, unit 860 applies an IFFT and, after a cyclic prefix insertion (not shown), filtering is applied by filter 870 and a signal transmitted 880.

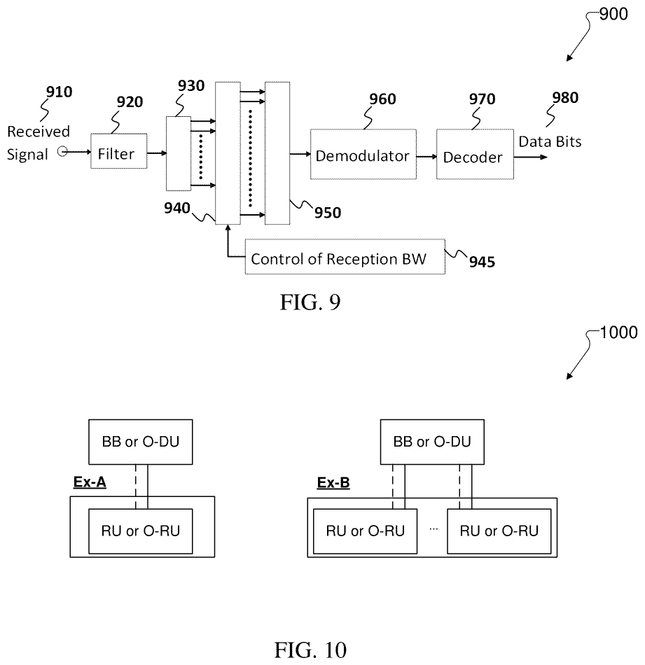

FIG. 9 illustrates an example of a receiver structure 900 for a PUSCH in a subframe according to embodiments of the present disclosure; For example, receiver structure 900 can be implemented by the UE 116 of FIG. 3. This example is for illustration only and other embodiments can be used without departing from the scope of the present disclosure.

As illustrated in FIG. 9, a received signal 910 is filtered by filter 920. Subsequently, after a cyclic prefix is removed (not shown), unit 930 applies a FFT, REs 940 corresponding to an assigned PUSCH reception BW are selected by a reception BW selector 945, unit 950 applies an Inverse DFT (IDFT), a demodulator 960 coherently demodulates data symbols by applying a channel estimate obtained from a DMRS (not shown), a decoder 970, such as a turbo decoder, decodes the demodulated data to provide an estimate of the information data bits 980.

Likewise, for a cellular system operating in low carrier frequency in general, a sub-1 GHz frequency range (e.g. less than 1 GHz) as an example, supporting large number of CSI-RS antenna ports (e.g. 32) or many antenna elements at a single location or remote radio head (RRH) or TRP is challenging due to a larger antenna form factor size needed taking into account carrier frequency wavelength than a system operating at a higher frequency such as 2 GHz or 4 GHz. At such low frequencies, the maximum number of CSI-RS antenna ports that can be co-located at a site (or RRH or TRP) can be limited, for example to 8. This limits the spectral efficiency of such systems. In particular, the MU-MIMO spatial multiplexing gains offered due to large number of CSI-RS antenna ports (such as 32) can't be achieved due to the antenna form factor limitation. One plausible way to operate a system with large number of CSI-RS antenna ports at low carrier frequency is to distribute the physical antenna ports to different panels/RRHs/TRPs, which can be non-collocated. The multiple sites or panels/RRHs/TRPs can still be connected to a single (common) base unit forming a single antenna system, hence the signal transmitted/received via multiple distributed RRHs/TRPs can still be processed at a centralized location.

The present disclosure relates generally to wireless communication systems and, more specifically, to efficient measurement and reporting of quality of layers in next generation of MIMO systems.

A communication system includes a DownLink (DL) that conveys signals from transmission points such as Base Stations (BSs) or NodeBs to User Equipments (UEs) and an UpLink (UL) that conveys signals from UEs to reception points such as NodeBs. A UE, also commonly referred to as a terminal or a mobile station, may be fixed or mobile and may be a cellular phone, a personal computer device, or an automated device. An eNodeB, which is generally a fixed station, may also be referred to as an access point or other equivalent terminology. For LTE systems, a NodeB is often referred as an eNodeB.

In a communication system, such as LTE, DL signals can include data signals conveying information content, control signals conveying DL Control Information (DCI), and Reference Signals (RS) that are also known as pilot signals. An eNodeB transmits data information through a Physical DL Shared CHannel (PDSCH). An eNodeB transmits DCI through a Physical DL Control CHannel (PDCCH) or an Enhanced PDCCH (EPDCCH)—see also REF 3. An eNodeB transmits acknowledgement information in response to data Transport Block (TB) transmission from a UE in a Physical Hybrid ARQ Indicator CHannel (PHICH). An eNodeB transmits one or more of multiple types of RS including a UE-Common RS (CRS), a Channel State Information RS (CSI-RS), or a DeModulation RS (DMRS). A CRS is transmitted over a DL system BandWidth (BW) and can be used by UEs to obtain a channel estimate to demodulate data or control information or to perform measurements. To reduce CRS overhead, an eNodeB may transmit a CSI-RS with a smaller density in the time and/or frequency domain than a CRS. DMRS can be transmitted only in the BW of a respective PDSCH or EPDCCH and a UE can use the DMRS to demodulate data or control information in a PDSCH or an EPDCCH, respectively. A transmission time interval for DL channels is referred to as a subframe (or slot) and can have, for example, duration of 1 millisecond.

DL signals also include transmission of a logical channel that carries system control information. A BCCH is mapped to either a transport channel referred to as a Broadcast CHannel (BCH) when it conveys a Master Information Block (MIB) or to a DL Shared CHannel (DL-SCH) when it conveys a System Information Block (SIB)—see also REF3 and REF 5. Most system information is included in different SIBs that are transmitted using DL-SCH. A presence of system information on a DL-SCH in a subframe (or slot) can be indicated by a transmission of a corresponding PDCCH conveying a codeword with a CRC scrambled with a special System Information RNTI (SI-RNTI). Alternatively, scheduling information for a SIB transmission can be provided in an earlier SIB and scheduling information for the first SIB (SIB-1) can be provided by the MIB.

DL resource allocation is performed in a unit of subframe (or slot) and a group of Physical resource blocks (PRBs). A transmission BW consists of frequency resource units referred to as Resource Blocks (RBs). Each RB consists of

$${N}_{s c}^{R B}$$

sub-carriers, or Resource Elements (REs), such as 12 REs. A unit of one RB over one subframe (or slot) is referred to as a PRB. A UE can be allocated M_{PDSCH} RBs for a total of

$${M}_{sc}^{PDSCH} = {M}_{PDSCH} \cdot {N}_{sc}^{RB}$$

REs for the PDSCH transmission BW.

UL signals can include data signals conveying data information, control signals conveying UL Control Information (UCI), and UL RS. UL RS includes DMRS and Sounding RS (SRS). A UE transmits DMRS only in a BW of a respective PUSCH or PUCCH. An eNodeB can use a DMRS to demodulate data signals or UCI signals. A UE transmits SRS to provide an eNodeB with an UL CSI. A UE transmits data information or UCI through a respective Physical UL Shared CHannel (PUSCH) or a Physical UL Control CHannel (PUCCH). If a UE needs to transmit data information and UCI in a same UL subframe (or slot), it may multiplex both in a PUSCH. UCI includes Hybrid Automatic Repeat reQuest ACKnowledgement (HARQ-ACK) information, indicating correct (ACK) or incorrect (NACK) detection for a data TB in a PDSCH or absence of a PDCCH detection (DTX), Scheduling Request (SR) indicating whether a UE has data in its buffer, Rank Indicator (RI), and Channel State Information (CSI) enabling an eNodeB to perform link adaptation for PDSCH transmissions to a UE. HARQ-ACK information is also transmitted by a UE in response to a detection of a PDCCH/EPDCCH indicating a release of semi-persistently scheduled PDSCH (see also REF 3).

An UL subframe (or slot) includes two slots. Each slot includes

$${N}_{symb}^{UL}$$

symbols for transmitting data information, UCI, DMRS, or SRS. A frequency resource unit of an UL system BW is a RB. A UE is allocated N_{RB} RBs for a total of

$${N}_{RB} \cdot {N}_{sc}^{RB}$$

REs for a transmission BW. For a PUCCH, N_{RB}=1. A last subframe (or slot) symbol can be used to multiplex SRS transmissions from one or more UEs. A number of subframe (or slot) symbols that are available for data/UCI/DMRS transmission is

$${N}_{symb} = 2 \cdot ( {N}_{symb}^{UL} - 1 ) - {N}_{SRS} ,$$

where N_{SRS}=1 if a last subframe (or slot) symbol is used to transmit SRS and N_{SRS}=0 otherwise.

As described herein, for low (FR1), high (FR2 and beyond), or mid (6-15 GHz) band, the NW topology/architecture is likely to be more and more distributed in future due to reasons explained herein (e.g. use cases, HW requirements, antenna form factors, mobility etc.). In this disclosure, such a distributed system is referred to as a DMIMO or multiple TRP (mTRP) system (multiple antenna port groups, which can be non-co-located). The transmission in such a system can be coherent joint transmission (CJT), i.e., a layer can be transmitted across/using multiple TRPs, or non-coherent joint transmission (NCJT). Due to distributed nature of operation, the groups of antenna ports (or TRPs) need to be calibrated/synchronized by compensating for the non-idealities such as time/frequency/phase offsets non-ideal backhaul across TRPs, due to HW impairments, different delay profiles, and Doppler profile (in high-speed scenarios) associated with different TRPs.

In one example, a TRP or RRH can be functionally equivalent to (hence can be replaced with) or is interchangeable with one of more of the following: an antenna, or an antenna group (multiple antennae), an antenna port, an antenna port group (multiple ports), a CSI-RS resource, multiple CSI-RS resources, a CSI-RS resource set, multiple CSI-RS resource sets, an antenna panel, multiple antenna panels, a Tx-Rx entity, a (analog) beam, a (analog) beam group, a cell, a cell group.

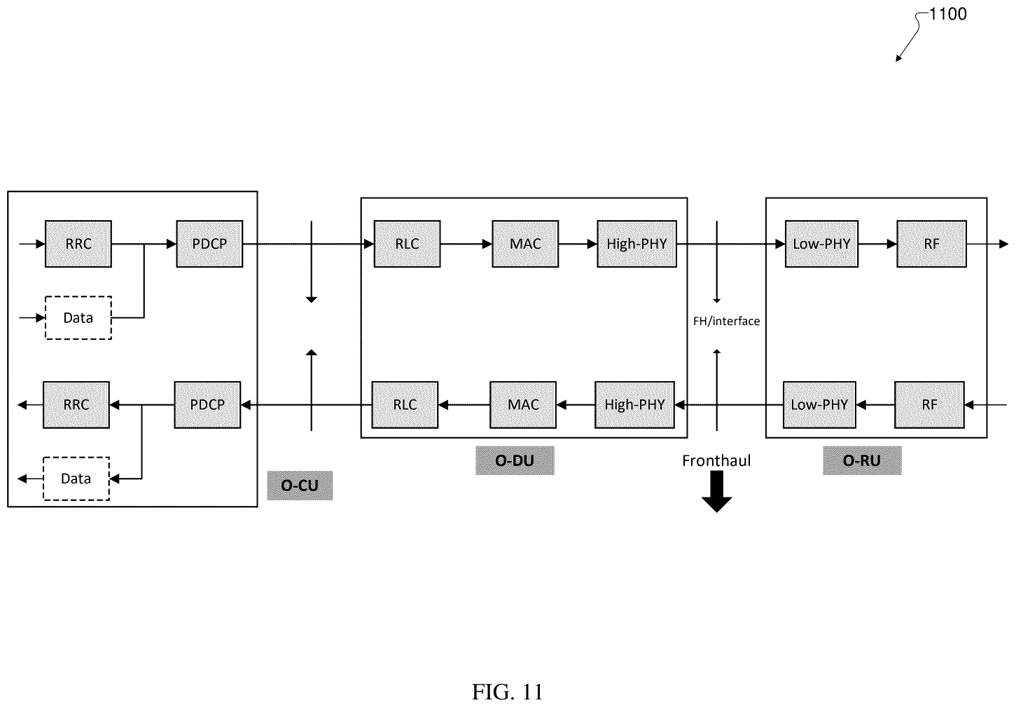

FIG. 10 illustrates example RAN configurations 1000 according to embodiments of the present disclosure. For example, RAN configurations 1000 can be implemented by the BS 102 of FIG. 1. This example is for illustration only and other embodiments can be used without departing from the scope of the present disclosure.

In an O-RAN NW architecture, a TRP can be functionally equivalent to (hence can be replaced with) or is interchangeable with one of more of the following:
One RU or O-RU: a logical node that includes a subset of the eNB/gNB functions (e.g. as listed in clause 4.2 split option 7-2×)
More than one RUs or O-RUs
One or more than one RUs or O-RUs

Two examples are shown in FIG. 10.

The following are defined in [REF11 and REF12].

| | |
|---|---|
| O-CU | O-RAN Central Unit - a logical node hosting PDCP, RRC, SDAP and other |
| | control functions |
| O-DU | O-RAN Distributed Unit: a logical node hosting RLC/MAC/High-PHY layers |
| | based on a lower layer functional split. O-DU in addition hosts an M-Plane |
| | instance. |
| O-RU | O-RAN Radio Unit: a logical node hosting Low-PHY layer and RF processing |
| | based on a lower layer functional split. This is similar to 3GPP's “TRP” or “RRH” |
| | but more specific in including the Low-PHY layer (FFT/iFFT, PRACH extraction). |
| | O-RU in addition hosts M-Plane instance. |

Networks (NW) up to 5G network can be described in terms of transmit-receive points (TRPs). For a first frequency range (FR1), i.e., <6 GHz, a TRP can comprise one or more antenna ports, and is fully-digital (i.e. each antenna port is driven by a dedicated baseband processing chain); and for a second frequency range 24.25-52.6 GHz (FR2), i.e., for mmWave frequencies, a TRP comprises one of more antenna panels (sub-arrays), each comprising one or two antenna ports that are controlled by analog phase shifters that result in an analog beam (pointing in certain spatial direction). An antenna port in FR1 can also be beamformed (aka virtualization); however, such a beamforming (BF) is generally static (non-adaptive, hence not requiring measurement and reporting). In FR2, due to large propagation loss at mmWave frequencies, each antenna panel requires dynamic/frequent update of the analog BF, which is often based on (analog) beam measurement and reporting.

A communication between the 5G NW and a user is broadly based on: (A1) NWresources, and (A2) signaling components, where the former corresponds to spatial-domain, frequency-domain, and time-domain (SD, FD, TD) resources allocated to the user for the communication, and the latter corresponds to components that are signaled over the NW resources. The SD resources can be based on a single TRP (sTRP) or multiple TRPs (mTRP), where mTRP can be (B1) co-located at a site/location or (B2) non-co-located/distributed at multiple sites/locations, where the latter corresponds to a distributed SD resource, hence the corresponding communication hypothesis can be (C1) non-coherent joint transmission (NCJT) where a data stream (layer) is transmitted from one of the mTRPs, or (C2) coherent JT (CJT), where a data stream (layer) can be transmitted from multiple of the mTRPs. The FD resources can comprise a set of physical resource blocks (PRBs), and the TD resources can comprise one or multiple time slots (i.e., 1 slot=N_{sym} consecutive symbols).

The signaling components include signaling associated with (D1) measurement, (D2) channel state information (CSI) report, and (D3) DL reception or UL transmission.

For (D1), the user measures channel measurement RSs (CMRs) to estimate the channel condition between the sTRP/mTRP and the user. In case of sTRP, the user can measure a set comprising one or multiple DL measurement resources. For mTRP, the measurement resources can be (E1) one resource set comprising one group per TRP, or (E2) one resource set per TRP. The user can also measure the interference based on interference measurement RSs (IMRs). A CMR can correspond to an analog beam, and can be repeated in multiple symbols for determining user's analog beam.

For (D2), the user, based on the measurement, determines the CSI and reports it to the NW, where the CSI can be (F1) (analog) beam-related CSI, or (F2) (digital) non-beam-related CSI. For (F1), the user determines one or multiple pairs (indicator, metric), where the indicator indicates a CMR and the metric indicates a (beam) quality (e.g. reference signal received power (RSRP), signal-to-interference-plus-noise ratio (SINR)).

For (F2), a low-resolution (Type-I) CSI and a high-resolution (Type-II) CSI are supported. The Type-I CSI is based on L=1 DFT SD vector per layer, requires low feedback overhead and is expected to work reasonably well for single user (SU)-MIMO. For multiuser-(MU-)MIMO transmission, however, high-resolution Type II CSI capturing multiple dominant directions of the channel is essential in order to suppress inter-user interference. The Type-II CSI is based on a weighted linear combination L>1 SD DFT vectors where the weights correspond to coefficients. The FD DFT vectors were additionally introduced enhanced Type-II CSI to reduce the CSI feedback overhead by compressing channel coefficients in both SD and FD. A further enhanced Type-II port-selection (PS) CSI was specified to further reduce the CSI overhead by exploiting a reciprocity of angle-and-delay domain between uplink and downlink channels. Assuming NW performs pre-processing with beamformed CSI-RS to concentrate angle-and-delay domain components in few SD and FD basis directions, the user can be configured to select a subset of antenna ports (at a TRP) and one or two FD vectors. Additionally, a NCJT Type-I CSI was supported for up to two TRPs and multiple (sTRP or NCJT) hypotheses. Furthermore, the enhanced Type-II CSI is extended to support CJT Type-II CSI from mTRP and for high/medium user velocities exploiting time-domain correlation or Doppler-domain information, respectively.

A transmission configuration indication (TCI) framework is shared between (non-beam-related) CSI and beam management (BM). While the complexity of such a TCI framework is justified for CSI acquisition in FR1, it makes BM procedures less efficient in FR2. Furthermore, the BM procedures can be different for different channels due to their different target scenarios. Having different beam indication/update mechanisms increases the complexity, overhead, and latency of BM. Such drawbacks are especially troublesome for high mobility scenarios (such as highway and high-speed train). These drawbacks motivated a streamlined BM framework for beam-based operations and procedures that is common for data and control, and uplink (UL) and downlink (DL) channels. This framework is referred to as a unified TCI (uTCI) framework, firstly introduced for sTRP and now being enhanced for mTRP.

The uTCI framework supports signaling of a unified TCI state to a user, where the unified TCI state can be a DL-TCI, an UL-TCI or a joint TCI (J-TCI) state, where a DL-TCI state is applied for receiving DL channels/signals, an UL-TCI state is applied for transmitting UL channels/signals, and a J-TCI state is applied for both DL and UL channels/signals. The uTCI framework is designed to support DL receptions and UL transmissions (i) with a joint (common) beam indication for DL and UL by leveraging beam correspondence (reciprocity between DL and UL), and (ii) with separate beam indications for DL and UL, for example to mitigate maximum permissible exposure, where the beam direction of an UL transmission is different from the beam direction of a DL reception to avoid exposure of the human body to radiation.

The uTCI framework can support a beam-level mobility, known as inter-cell BM (ICBM). In ICBM, the user-dedicated channels can be configured to use a beam (i.e., TCI state) associated with a (non-serving) cell having a physical cell identity (PCI) that is different from the PCI of the serving cell. This allows fast beam-switch to a non-serving cell for user-dedicated channels at a lower layer without involving a higher layer and without incurring latency and overhead of handover.

The ICBM is being further enhanced to support a complete cell-switch triggered by lower layers, which is known as lower-layer triggered mobility (LTM). In LTM, the NW can acquire beam measurements, and UL timing information for target candidate cells before cell-switch. The lower layers of the NW decide when to perform a cell-switch, and send a medium access control channel element (MAC CE) containing a cell-switch command (CSC) that triggers the cell-switch from a source cell to a target cell. The CSC includes beam (i.e., TCI state) and UL timing information for the user to use on the target cell. After a beam application delay, the user and the NW communicates via the target cell.

NW energy saving (NES) is another advanced feature, wherein the NW can optimize energy usage by turning TRPs ON/OFF, thereby saving power. From a user's perspective, this is akin to dynamic SD resource update between transmissions. The CSI in the NES scenario can be based on multiple sub-configurations, each corresponding to different SD resource assignments, and dynamically (via downlink control information (DCI)) triggering one or multiple of the sub-configurations for CSI reporting.

Full-duplex transmission and reception in the same NR channel BW or using non-contiguous intra-band carrier aggregation (CA) is a promising technology to enhance UL coverage, reduce latency and improve system capacity and to overcome limitations inherent to the use of de-facto mandated semi-static time division duplexing (TDD) UL-DL frame configurations in today's NR TDD deployments. Currently, 3GPP is studying benefits, feasibility and deployment scenarios for enabling NW-side full-duplex operation where simultaneous transmissions and receptions by the NW on the same time-domain symbol on the NR carrier can only occur in non-overlapping UL and DL subbands, e.g., subband full-duplex (SBFD) mode. In this first step of NR duplex evolution, users with support for NW-side SBFD operation still operate in half-duplex, i.e., the user can either transmit or receive on an SBFD symbol but not transmit and receive simultaneously. An SBFD UL subband can be located in the center or at the edge of the NR carrier in FR1 or FR2-1. For CA-based SBFD in FR2-1, one component carrier (CC) is allocated for UL transmissions whereas the remaining CCs are used for DL transmission.

NW-side self-interference cancellation (SIC) capability to enable SBFD can be realized through a combination of solutions. For example, the NW can use Tx/Rx antenna isolation on the antenna panel(s), beam steering, analog and/or digital pre-distortion, digital interference cancellation, and analog and/or digital filtering solutions. Note that passive Tx/Rx antenna isolation has been demonstrated to achieve in excess of 80 dB in FR1 with even higher isolation in FR2-1. For example, SBFD for the Local Area base station class characterized by small Tx power and reduced Rx sensitivity can already achieve a significant amount of SIC capability by relying on antenna isolation alone. Wide Area base stations characterized by much higher transmit power and higher Rx sensitivity may need to implement a more extensive set of solutions to support SBFD.

NW-side SBFD operation can be enabled transparently for NR users and has been shown feasible and providing gains. In this case, users are scheduled UL transmissions in the SBFD UL subband of the NR carrier on symbols configured as flexible by SIB1. More gains in the NR TDD cell supporting NW-side SBFD operation can be achieved in presence of SBFD-aware users, e.g., supporting resource allocation enhancements for PDSCH, PUSCH and physical uplink control channel (PUCCH) including handling of TCI states and BF, and CSI reporting enhancements to best exploit the link conditions on SBFD and non-SBFD slots/symbols on the serving cell.

As explained, the 5G NW can support several features, services, use cases, and deployment scenarios. It however also introduces too many different abstractions (for specification) of NW entities and involved signaling for components of these abstractions. For instance, the specification supports abstractions for single-cell, multi-cell, sTRP, mTRP, panel, antenna panel, antenna port, resource, resource set, and beam; and signaling for a complicated CSI framework based on components such as CSI resource setting (one or more CSI-RS resources sets, each with one or more CSI-RS/synchronization signal block (SSB) resources) and CSI report setting that links a CSI resource setting to a report quantity from a set of multiple supported report quantities, wherein a report quantity can correspond to beam report (i.e. an analog beam and a beam quality) or a non-beam report (i.e. rank indicator (RI), precoding matrix indicator (PMI), channel quality indicator (CQI), CQI report interval (CRI)). In addition, for PMI, too many different codebooks are supported. Due to these reasons, deployment of the 5G NW is challenging in reality. A direct scaling/extension/reuse up to 5G solutions for 6G will add to the complexity, which is undesired in real NW deployments.

FIG. 11 illustrates a diagram of example functional split points/options 1100 according to embodiments of the present disclosure. For example, functional split points/options 1100 may be implemented by the BS 102 of FIG. 2. This example is for illustration only and other embodiments can be used without departing from the scope of the present disclosure.

In next-gen MIMO systems (e.g. 6G), at least two aspects need to be taken into account.
(A) 3GPP PHY specification: The significance of a single NW entity, namely PG (as a collection of ports) in terms of port-common channel properties. This is analogous to the 5G QCL (or TCI state), coherency assumption (e.g. FC, PC, NC).
(B) NW architecture as perceived in O-RAN: The functionality split among O-RAN entities for DL and UL operations, such as O-RU, O-DU, and O-CU (as described herein). An example is shown in FIG. 11. In particular, the PHY functionality split between O-DU and O-RU includes at least the following aspects.
   (B1) PHY processing:
      bit-level processing,
      symbol-level processing
   (B2) Scheduling (residing in MAC): SU-MIMO/MU-MIMO scheduling across different O-RUs or/and allocated frequency-domain resources (e.g. PRBs, precoding resource block groups (PRGs), subbands (SBs))
      Utilizing uplink control information (UCI) carrying CSI
      If DL/UL reciprocity is feasible, also utilizing sounding reference signal (SRS)-based channel measurement
   (B3) Precoder calculation at a gNB (NW side) for DL-SCH transmission:
      For SU-MIMO, precoder can simply follow the PMI (calculated assuming SU-MIMO hypothesis) reported by the UE, or, if DL/UL reciprocity is feasible, be calculated from the eigenvector(s) of the measured DL channels.
      For MU-MIMO, precoder needs to be calculated based on additional orthogonalization (e.g. zero-forcing beamforming (ZFBF), signal-to-leakage-and-noise-ratio (SLNR)) among PMIs, or, if DL/UL reciprocity is feasible, the eigenvectors of the measured channels of the co-scheduled UEs

The first (A) can be achieved by removing/merging duplicate/redundant abstractions, and simplifying signaling for components of the abstractions. One such framework, namely dynamic MIMO, is provided in this disclosure, wherein abstractions such as CSI-RS resource, CSI-RS resource set, port, beam, TRP, panel etc. can be clubbed into one basic entity, namely antenna/port group (PG or O-RU (or RU)), and essential features of PGs are specified. A few essential features discussed include dynamic PG or O-RU (or RU) selection and long-term stats and assumptions across PGs, e.g., quasi co-location (QCL) and coherency relationships across PGs. The provided framework can also facilitate fast and accurate CSI acquisition, where the CSI can be beam-related (e.g. beam indicator, beam metric), non-beam-related (e.g. RI/PMI/CQI), or both. Additionally, the concept of a cell is replaced with PGs that are distributed through the NW. The mobility can be handled via the PG or O-RU (or RU) selection/update (from one set of PGs to another set of PGs).

A few relevant (more-probable) candidates discussed in the O-RAN Alliance (depicted in FIG. 11) are shown in Table 1.

TABLE 1
(both DL and UL)

| | | | | | | | |
|---|---|---|---|---|---|---|---|
| | | | High- | Low- | | | |
| PDCP | RLC | MAC | PHY | PHY | RF | HLS | LLS |

| | | | | | |
|---|---|---|---|---|---|
| O-RAN¹ | O-CU: | O-DU: RLC, | O-RU: | Y | symbol- |
| (Opt7-2x) | PDCP | MAC, High-PHY | Low-PHY, RF | | level PHY |
| Opt7-3 | O-CU: | O-DU: RLC, | O-RU: | Y | bit-level |
| | PDCP | MAC, High-PHY | Low-PHY, RF | | PHY |

| | | | | |
|---|---|---|---|---|
| Opt8 | DU: RLC, MAC, PHY | RU: | Y | CPRI |

RF

O-RAN¹: [REF 12]

Cat-A, Cat-B
UL: Cat-C

The 5G NR MIMO inherits a number of unnecessary hierarchical specification entities from 4G LTE. In relation to multi-antenna (MIMO), such entities include:
Pointless “middlemen” abstractions such as resource and resource-set entities for RS
Obsolete implementation-based abstractions, e.g., for panel, multi-panel, “TRP”, FR1 port vs FR2 beam/resource, “cell”

In next-generation systems, (e.g. 6G), the MIMO framework can be simplified/streamlined in order to (i) support both systems/networks (up to 5G) and new frequency bands (e.g. FR3), (ii) enable new features/services (such as AI/ML-based learning, evolved duplexing, and energy saving), (iii) make it implementation friendly, and (iv) have a future-proof and easily upgradable system.

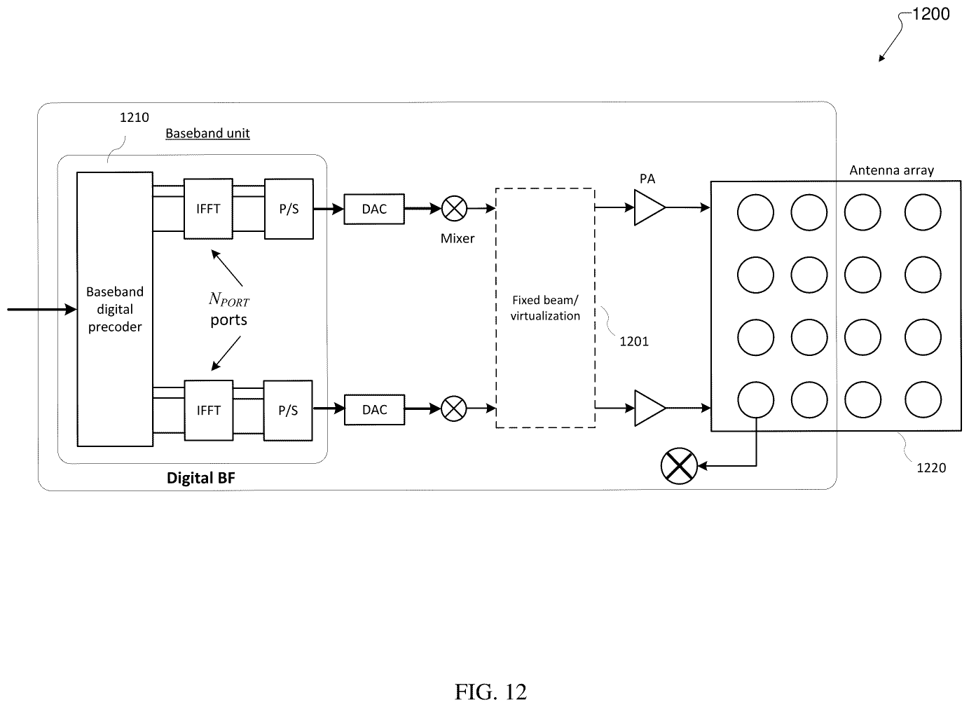

FIG. 12 illustrates an example of a fully digital transmitter structure 1200 for beamforming according to embodiments of the present disclosure. For example, fully digital transmitter structure 1200 can be implemented in the BS 103 of FIG. 1. This example is for illustration only and other embodiments can be used without departing from the scope of the present disclosure.

The fully digital transmitter structure 1200 includes a digital beamformer 1210, a fixed beam/virtualization 1201, and antenna array angles 1220.

A 5G NW can be built upon a spatial resource entity, say X. For a first frequency range (FR1), i.e., <6 GHz, the spatial entity X comprises one or more antenna ports that are fully-digital (i.e. each antenna port is driven by a dedicated baseband processing chain), as shown in FIG. 12; and for a second frequency range 24.25-52.6 GHz (FR2), i.e., for mmWave frequencies, the entity X comprises one or more antenna panels (sub-arrays), each comprising one (or two) antenna ports that is (are) controlled by analog phase shifters that result in an analog beam (pointing in certain spatial direction), as shown in FIG. 5. An antenna port in FR1 can also be beam-formed (aka virtualization); however, such a beamforming (BF) is generally static (non-adaptive, hence does not requiring measurement and reporting). In FR2, due to large propagation loss at mmWave frequencies, each antenna panel requires dynamic/frequent update of the analog BF, which is often based on (analog) beam measurement and reporting.

Thus, the main difference between a FR1 port and a FR2 panel is that the beam/virtualization (i.e. port assignment) is fixed in the former, and it requires (a) measurement and reporting from UE and (b) a beam indication from the NW (TCI state with QCL-TypeD). It is therefore plausible to have a unified framework in which a port in FR1 and a panel in FR2 can be abstracted based on a unified, band-agnostic spatial entity, e.g. port or port group (PG), and associated QCL and coherency properties across ports or PGs (intra-/inter PG). For instance,
Port: a FR1 port and a FR2 beam/source
Port group (PG): TRP, resource, resource set, panel, cell

While the O-RAN Alliance is intended for 5G NR, it is expected that its framework will continue, or at most refined, for 6G. The O-RAN Alliance specifies 3 levels of functional splits—namely CU, DU, and RU—to facilitate multi-vendor inter-operability within a NW. The manner in which PHY-layer functions are split between DU and RU(s) imposes serious impact on the feasibility, performance, and complexity of different MIMO schemes—mainly due to the latency and quantization loss incurred by the O-RAN-standardized RU-DU interface.

Instead of reusing the 4G/5G abstraction of CSI-RS resource or resource set, the terms “port” as a spatial-domain resource unit and “port group” (PG) as a collection of ports sharing a same set of channel properties are used irrespective of the frequency band. In this sense, a “port” can be associated with a digital port in FR1 or an analog beam in FR2 (thereby abandoning the 5G association between an analog beam and a CSI-RS resource for FR2).

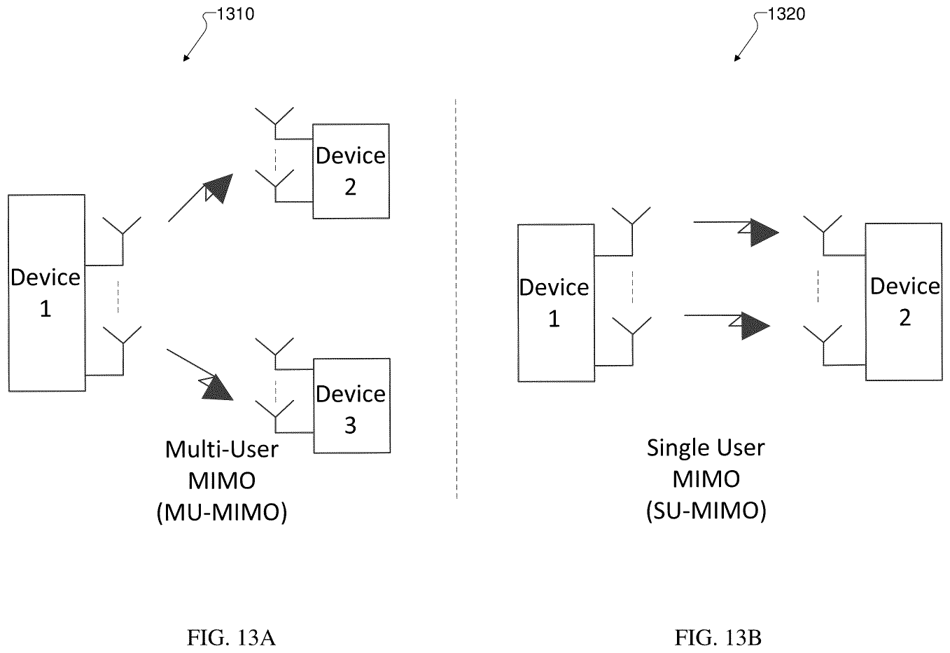

FIGS. 13A and 13B illustrate examples of MIMO transmission systems 1310 and 1320 according to embodiments of the present disclosure. For example, MIMO transmission systems 1310 and 1320 can be implemented within the wireless network 100 of FIG. 1. This example is for illustration only and other embodiments can be used without departing from the scope of the present disclosure.

The technique of MIMO transmission (or spatially multiplexing) is a well-known technique for increasing the spectral efficiency of a communication link, by enabling multiple streams to be sent at the same time and frequency resources. MIMO transmission can be categorized into two different techniques: single user MIMO (SU-MIMO) and multi-user (MU-MIMO). SU-MIMO supports only one user and can only maintain one communication link at one time. MU-MIMO, however, can support multiple users and therefore can support several links at the same time. An illustration of the difference between SU-MIMO and MU-MIMO is shown in FIG. 13.

There is capacity (spectral efficiency) benefits for MU-MIMO transmission for communication systems which allow one communication entity to communicate with more than one other entity at the same time. Examples of such systems include cellular mobile communications and indoor WLAN (wireless local area networks) or Wi-Fi systems. Presently MU-MIMO is used in a number of different communication standards in conjunction with digital beam-forming or a hybrid of RF/analog and digital beam-forming. Examples of such systems are IEEE 802.11ac and the 4G LTE and 5G NR standards. For the case of IEEE 802.11ac, device 1 (as seen in FIG. 13a) the MU-MIMO serving device is typically the access point (AP) and for the case of 4G LTE and 5G NR, the MU-MIMO serving device is typically a base station (e.g., the BS 102) (or eNB or gNB). It is very likely that MU-MIMO will be used for future generation of cellular communications systems (i.e. 6G) or future generations of indoor WLAN or Wi-Fi communications systems.

For MU-MIMO to function effectively it is essential that the interference between the co-scheduled links is minimized. By referring to the example shown in FIG. 13(a) the co-scheduled links are the communication links between the MU-MIMO serving device (device 1) and devices 2 and 3. This interference is reduced by using MU-MIMO pre-coding schemes at the MU-MIMO serving device (device 1) which reduces the interference of the co-scheduled users to each other by carefully beam-forming each users signal in such a way so as to minimize the interference to the other co-scheduled users. Example of MU-MIMO pre-coding schemes include both linear (examples of which are block diagonalization, coordinated beam forming, MMSE/ZF beam forming, etc.) and non-linear (vector perturbation, Tomlinson-Harashima pre-coding, etc.) techniques.

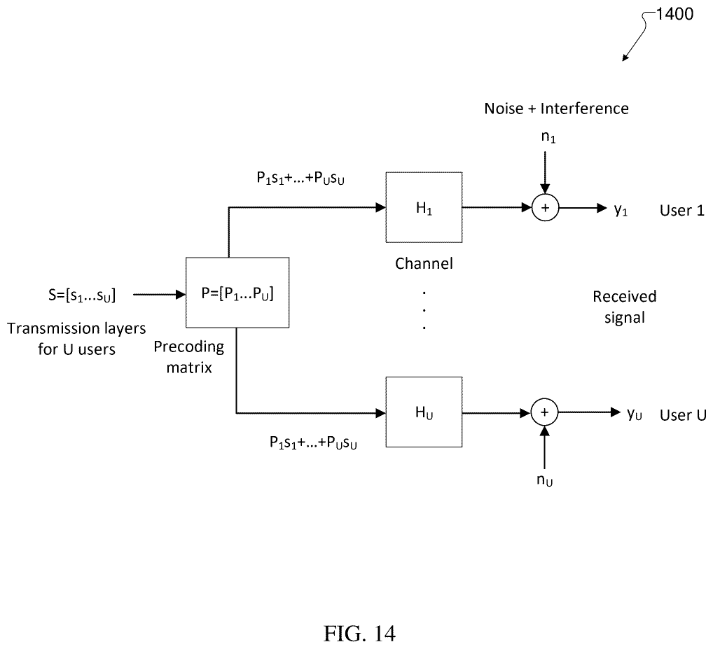

FIG. 14 illustrates an example MU-MIMO configuration 1400 according to embodiments of the present disclosure. For example, the BS 102 of FIG. 1. can configure MU-MIMO configuration 1400. This example is for illustration only and other embodiments can be used without departing from the scope of the present disclosure.

An example of MU-MIMO communication system with linear pre-coder is depicted in FIG. 14. Let U be the number of users and N_{s,i} be the number of streams sᵢ for user i. Let S be a Nₛ-dimensional vector, where

$${N}_{s} = {\sum }_{i = 1}^{U} {N}_{s , i} ,$$

containing the transmitted streams for the users. Let Nₜ be the number of antennae (or antenna ports) at the transmitter (e.g. BS/gNB) and Nᵣ_{ᵢ} be the number of receiving antennae (or antenna ports) at user i. The transmitter pre-codes the streams using an Nₜ×Nₛ MU-MIMO pre-coding matrix P and then transmits the pre-coded streams PS=P₁s₁+ . . . +P_{U}s_{U} over the channel. The received signal at user i is given by

$${y}_{i} = {H}_{i} P s + {n}_{i} = {H}_{i} {P}_{i} {s}_{i} + {\sum }_{j \neq i} {H}_{i} {P}_{j} {s}_{j} + {n}_{i} ,$$

where Hᵢ is the Nᵣ_{ᵢ}×Nₜ MIMO channel matrix for user i, Pᵢ is the Nₜ×N_{s,i} pre-coding matrix for user i, and nᵢ is the Nᵣ_{ᵢ}×1 additive noise (plus interference) vector for user i. The total Nᵣ×Nₜ, where Nᵣ=ΣᵢNᵣ_{ᵢ}, multi-user MIMO channel is given by

$${H}_{multi - user} = [ \begin{matrix}{H}_{1} \\ ⋮ \\ {H}_{U}\end{matrix} ] .$$

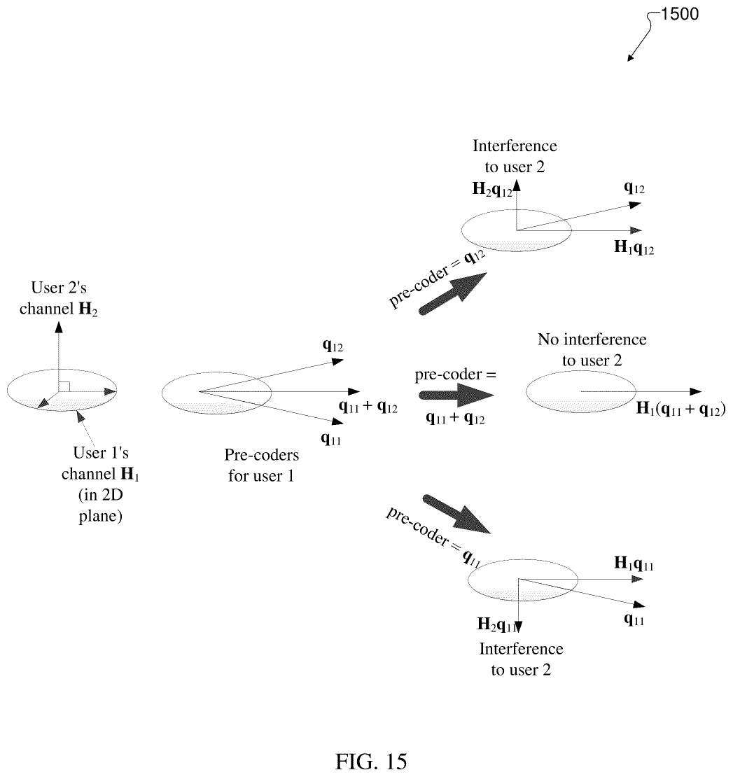

FIG. 15 illustrates example pre-coders 1500 according to embodiments of the present disclosure. For example, pre-coders 1500 can be utilized by the BS 102 of FIG. 2. This example is for illustration only and other embodiments can be used without departing from the scope of the present disclosure.

In one example, the MMSE-based MU-MIMO pre-coding scheme can be described as follows. The MMSE pre-coder is denoted for users by the Nₜ×UNₛ P_{MMSE}. The MMSE pre-coding scheme uses Hₘᵤₗₜᵢ₋ᵤₛₑᵣ to calculate P_{MMSE} as follows. Let

$$Q = {{H}_{multi - user}^{H} ( {H}_{multi - user} {H}_{multi - user}^{H} + cI )}^{- 1} = [ {Q}_{1} {Q}_{2} … {Q}_{{N}_{u}} ] ,$$

where the constant c is calculated based on the norm of Hₘᵤₗₜᵢ₋ᵤₛₑᵣ and the noise variance, and Qᵢ is the Nₜ×Nᵣ_{ᵢ} matrix that is used to obtain the pre-coding matrix for user i. For the case when the number of antenna at each user is one (i.e. N_{s,i}=Nᵣ_{ᵢ}=1), the MMSE pre-coder is given by P_{MMSE}=Q. The performance of the MMSE pre-coding scheme in this case is quite good. However, for the case when the number of streams for user i is lower than number of antennae at user i (Nₛ<Nᵣ_{ᵢ}), it is unclear how to obtain the final pre-coder for user i from Qᵢ (because the column dimensions of Pᵢ and Qᵢ do not match). One simple solution is to take the first Nₛ columns out of Nᵣ_{ᵢ} columns of Qᵢ as the pre-coder for each user i. However, this does not lead to good performance. The following examples can be used to improve performance in this case.

In one example, a full exhaustive search (dynamic search) is performed over pre-coder combinations (extracted from the columns of Qᵢ) across the users, and choose the best pre-coder combinations based on a given metric (The choice is based on different metrics. These metrics are described in more detail herein).

This is referred to as MMSE (Exhaustive) pre-coding scheme. The complexity of this scheme is

$$O ( {( \begin{matrix}{N}_{{r}_{i}} \\ {N}_{s}\end{matrix} )}^{U} ) ,$$

which could be prohibitive in practice.

In one example, an iterative user-wise exhaustive search is performed which searches over pre-coders (extracted from columns of Qᵢ) for user i to find the best pre-coder, assuming that the pre-coders for the rest of the users (all users j≠i) are already fixed from the columns of Qⱼ (The different metrics will be described herein). This process is then repeated for the users iteratively until some convergence criterion is met. The best pre-coder combinations at the time convergence are the final pre-coders. This scheme is referred to as MMSE (Iterative) pre-coding scheme. The complexity of this scheme is

$$O ( ( \begin{matrix}{N}_{{r}_{i}} \\ {N}_{s}\end{matrix} ) \times M ) ,$$

where M is the number of iterations until the scheme converges.

In the previous two examples, the pre-coders are restricted to be from the columns of Qᵢ. There could be some other better pre-coders that can be obtained from Q. For example, for the case of two users (U=2), one stream for each user (Nₛ=1), and two receiving antennae at each user (Nᵣ_{₁}=Nᵣ_{₂}=2),

$$Q = [ {Q}_{1} {Q}_{2} ] , where {Q}_{1} = [ {q}_{11} {q}_{12} ] and {Q}_{2} = [ {q}_{21} {q}_{22} ] .$$

Therefore, the sums of the columns of Q₁ and Q₂ as the pre-coders for user 1 and 2 are taken into account, respectively, i.e.

$${P}_{1} = {q}_{11} + {q}_{12} and {P}_{2} = {q}_{21} + {q}_{22} .$$

With reference to FIG. 15, an example is shown in which the pre-coders obtained by summing the columns of Qᵢ could be better than the pre-coders chosen from the columns of Qᵢ. As depicted, the sum pre-coder does not interfere with the channel of user 2 whereas both column pre-coders interfere. Therefore a few embodiments are presented about how to use Q to obtain better pre-coders.

In one example, the pre-coder for user i is obtained from the space spanned by the columns of Qᵢ. In other words, the pre-coder is selected from the set of weighted linear combinations of the columns of Qᵢ. The best pre-coder combination from the sets of weighted linear combinations of Qᵢ for i is the final pre-coder (The different metrics are described herein). This scheme is referred to as MMSE (LC) pre-coding scheme.

In the following, the notation L(Qᵢ) is used to denote the set of weighted linear combinations of the columns of Qᵢ. Formally, it is defined a

$$L ( {Q}_{i} ) {=}^{Δ} \{ {\sum }_{j = 1}^{{N}_{{r}_{i}}} {w}_{j} {q}_{i j} such that {w}_{j} are real numbers and {q}_{ij} are columns of {Q}_{i} \} . \qquad ( 1 )$$

In one example, a full exhaustive search (dynamic search) is performed over pre-coder combinations extracted from L(Qᵢ) in (1) and across the users, and choose the best pre-coder combinations (The different metrics are described herein). This is referred to as MMSE (LC, Exhaustive) pre-coding scheme.

In one example, an iterative user-wise exhaustive search is performed in which a search over pre-coders extracted from L(Qᵢ) for user i to find the best pre-coder, assuming that the pre-coders for the rest of the users (all users j≠i) are already fixed from the columns of L(Qⱼ) (The different metrics are described herein). This process is then repeated for the users iteratively until some convergence criterion is met. The best pre-coder combinations at the time convergence are the final pre-coders. This scheme is referred to as MMSE (LC, Iterative) pre-coding scheme.

A few examples on the specific choice of weights in the last three examples are provided next.

In one example, the singular value decomposition (SVD) approach is used to find the weights of the linear combinations in the previous embodiments. In order to achieve this, the channel of user i on the space spanned by the columns of Qᵢ is projected and then perform the SVD of the projected channel, i.e.

$$SVD ( {H}_{i} {Q}_{i} ) = {U}_{i} {D}_{i} {V}_{i}^{H} = {U}_{i} {{D}_{i} [ {V}_{i}^{( {N}_{s} )} {V}_{i}^{( {N}_{{r}_{i}} - {N}_{s} )} ]}^{H} ,$$

where Uᵢ and Vᵢ are Nᵣ_{ᵢ}×Nᵣ_{ᵢ} orthonormal matrices whose columns are left and right singular vectors of HᵢQᵢ, and Dᵢ is the diagonal matrix whose diagonal entries are nonnegative singular values of HᵢQᵢ sorted in the descending order. The first Nₛ columns of Vᵢ

$$( i . e . {V}_{i}^{( {N}_{s} )} )$$

are used as weights in the linear weighted combinations of the columns of Qᵢ. The pre-coder for user i is then given by

$${P}_{MMSE , i} = \frac{{Q}_{i} {V}_{i}^{( {N}_{s} )}}{‖ {Q}_{i} {V}_{i}^{( {N}_{s} )} ‖} ,$$

$$where ‖ {Q}_{i} {V}_{i}^{( {N}_{s} )} ‖$$

denotes the norm of

$${Q}_{i} {V}_{i}^{( {N}_{s} )} .$$

This scheme is referred to as MMSE (SVD).

In the previous example, the first Nₛ columns of Vᵢ are chosen as weights for each user i. In the next two examples, search is performed from the columns of Vᵢ for the best weights. For that, R=[Q₁V₁ Q₂V₂ . . . Q_{N}_{ᵤ}V_{N}_{ᵤ}] is defined.

In one example, a full exhaustive search (dynamic search) is performed over pre-coder combinations (extracted from the columns of QᵢVᵢ) across the users, and choose the best pre-coder combinations based on a given metric (The different metrics are described herein). This is referred to as MMSE (SVD, Exhaustive) pre-coding scheme.

In one example, an iterative user-wise exhaustive search may be performed in which a search is performed over pre-coders (extracted from columns of QᵢVᵢ) for user i to find the best pre-coder, assuming that the pre-coders for the rest of the users (all users j≠i) are already fixed from the columns of QⱼVⱼ (The different metrics are described herein). This process is then repeated for the users iteratively until some convergence criterion is met. The best pre-coder combinations at the time convergence are the final pre-coders. This scheme is referred to as MMSE (SVD, Iterative) pre-coding scheme.

In one example, the overall channel Hₘᵤₗₜᵢ₋ᵤₛₑᵣ and Q may be used to further reduce the interference to any user from the rest of the users before performing the SVD-based pre-coder selection as in previous embodiments. Techniques such as diagonalization may be used to achieve this.

In one example, water-filling (i.e. unequal) type power allocation across users and streams is provided in previous examples.

In previous examples, there are different metrics for deciding how to choose the different pre-coders. In the following, different further embodiments are described for these metrics.

In one example, the metric in previous examples may be the overall channel capacity.

In one example, the metric in previous examples may be the overall SINR.

In one example, the metrics in last two examples may be based on
1. the per-subcarrier channel (in systems with orthogonal subcarriers such as OFDM), or
2. the per-subcarrier covariance matrix of the channel (in systems with orthogonal subcarriers such as OFDM), or
3. the average sub-band channel, where average is over the subcarriers in the sub-band, or
4. the average sub-band covariance matrix of the channel, where average is over the subcarriers in the sub-band.

In one example, for block diagonalization (BD) MU-MIMO precoding scheme, the calculation of the pre-coder for each user i is done in several steps. The first step is to calculate the effective channel matrix for users excluding user i,

$${\overline{H}}_{multi - user , user i removed} = [ \begin{matrix}{H}_{1} \\ ⋮ \\ {H}_{i − 1} \\ {H}_{i + 1} \\ ⋮ \\ {H}_{U}\end{matrix} ] \text{.}$$

The SVD is then performed on this effective channel matrix,

$$SVD ( {\overline{H}}_{multi - user , user i removed} ) = {\overline{X}}_{i} {\overline{\sum }}_{i} {\overline{Z}}_{i}^{H} = {\overline{X}}_{i} {{\overline{\sum }}_{i} [ \begin{matrix}{\overline{Z}}_{i}^{( 1 )} & {\overline{Z}}_{i}^{( 0 )}\end{matrix} ]}^{H} , \qquad ( 2 )$$

where X̅ᵢ and Z̅ᵢ are orthonormal matrices of left and right singular vectors, Σ̅ᵢ is the diagonal matrix with singular values as diagonal elements in decreasing order, and

$${\overline{Z}}_{i}^{( 1 )} and {\overline{Z}}_{i}^{( 0 )}$$

are the signal space and the null space of H̅ₘᵤₗₜᵢ₋ᵤₛₑᵣ, user i removed, i.e.,

$${\overline{H}}_{multi - user , user i removed} {\overline{Z}}_{i}^{( 1 )} \neq 0$$

$${\overline{H}}_{multi - user , user i removed} {\overline{Z}}_{i}^{( 0 )} = 0.$$

The SVD is then performed on the effective channel for user i projected on the null space

$${\overline{Z}}_{i}^{( 0 )} ,$$

$$SVD ( {H}_{i} {\overline{Z}}_{i}^{( 0 )} ) = {X}_{i} {\sum }_{i} {Z}_{i}^{H} = {X}_{i} {{\sum }_{i} [ \begin{matrix}{Z}_{i}^{( {N}_{0} )} & {Z}_{i}^{( {N}_{o} - {N}_{s} )}\end{matrix} ]}^{H} ,$$

where N₀ is the number of columns in

$${\overline{Z}}_{i}^{( 0 )}$$

and the vector

$${Z}_{i}^{( {N}_{s} )}$$

is extracted. The final pre-coding P_{BD,i} for user i is then calculated as

$${P}_{B D , i} = {\overline{Z}}_{i}^{( 0 )} {Z}_{i}^{( {N}_{s} )} .$$

This process is repeated for users to form the final matrix P. For the optimal performance, water filling (unequal power allocation) across different user streams can also be applied. The challenging part with BD, however, is how to optimally select the null space vector

$${\overline{Z}}_{i}^{( 0 )}$$

in equation (2) assuming it exists. Also, the BD algorithm needs to be generalized for the case in which

$${\overline{Z}}_{i}^{( 0 )}$$

does not exist. Examples of such generalization next are described.

In one example, for BD to yield a null space

$${\overline{Z}}_{i}^{( 0 )} ,$$

a necessary condition is that the number of columns in Z̅ᵢ is greater than the number of rows of H̅ₘᵤₗₜᵢ₋ᵤₛₑᵣ, user i removed. To fulfill this condition, Nₜ>E_{j≠i}Nᵣ_{ⱼ} must be satisfied for user i. To enhance BD therefore, when the number of RF chains at the transmitter Nₜ is low, i.e. when Nₜ≤Σ_{j≠i}Nᵣ_{ⱼ}, due to the lack of null space dimension, the columns of Z̅ᵢ can be searched, corresponding to low singular value(s), to form the best matrix

$${\overline{Z}}_{i}^{( 0 )}$$

to maximize capacity. This can be iteratively done on a per user basis or all users together. The scheme is summarized in Table 2.

TABLE 2
Enhanced BD algorithm

```
SVD of the interference: For each user i, compute
SVD of the interference from the rest of the users
$\begin{matrix}SVD ( {\overline{H}}_{eff ( multi - user , user i removed )} ) = {\overline{X}}_{i} {\overline{Σ}}_{i} {\overline{Z}}_{i} \\ = {\overline{X}}_{i} {\overline{Σ}}_{i} [ {\overline{Z}}_{i}^{( {N}_{BS} - r )} {\overline{Z}}_{i}^{( r )} ] ,\end{matrix}$
$where {\overline{Z}}_{i}^{( r )} denotes r columns extracted from {\overline{Z}}_{i} .$
    Initialize: S = {Nₛ, ... , N_{BS}}
C*(total with int. ) = 0
        Iterate:
  For ∀r₁ ∈ S, ∀r₂ ∈ S, ... ... , ∀r_{N}_{ᵤ} ∈ S
      For ∀i ∈ {1,2, ... , Nu}
$\begin{matrix}SVD ( {H}_{eff , i} {\overline{Z}}_{i}^{( {r}_{i} )} ) = {X}_{i} {Σ}_{i} {Z}_{i} \\ = {X}_{i} {Σ}_{i} [ {Z}_{i}^{( {N}_{s} )} {Z}_{i}^{( {N}_{0} - {N}_{s} )} ]\end{matrix}$
${P}_{BD , i} = {\overline{Z}}_{i}^{( {r}_{i} )} {Z}_{i}^{( {N}_{s} )}$
end
Compute C(total with int. ) using P_{BD,i}.
If C(total with int. ) > C*(total with int. )
C*(total with int. ) = C(total with int. )
${P}_{BD , i}^{*} = {P}_{BD , i}$
end
end
```

In one example, for SLNR-based MU-MIMO precoding scheme, SLNR can be calculated for user i as

$${SLNR}_{i} = \frac{{H}_{i} {P}_{i}}{{N}_{{r}_{i}} {σ}_{i}^{2} + {\sum }_{k = 1 , k \neq i}^{U} {H}_{k} {P}_{i}} .$$

The optimal SLNR MU precoder can be derived as

$${P}_{i}^{opt} = {( {N}_{{r}_{i}} {σ}_{i}^{2} I + {\tilde{H}}_{i}^{*} {\tilde{H}}_{i} )}^{- 1} {H}_{i}^{*} {H}_{i}$$

where \tilde{H}ᵢ=H̅_{multi-user, user i removed}.

When Hₘᵤₗₜᵢ₋ᵤₛₑᵣ is known at the transmitter, the MU scheduling and pre-coding matrix P can be determined based on a MU-MIMO precoding scheme such as ZF, MMSE, SLNR, block diagonalization etc. In a TDD system, exploiting channel reciprocity at the transmitter (gNB), Hᵢ for each user i and hence Hₘᵤₗₜᵢ₋ᵤₛₑᵣ can be estimated based on SRS measurement at the transmitter (gNB) (e.g., the BS 102), where the SRS is transmitted by each user separately. In an frequency division duplexing (FDD) system, however, the transmitter (gNB) relies on a CSI report κᵢ from each user i in order to obtain an information about the channel Hᵢ, where the CSI report κᵢ assumes a SU-MIMO transmission hypothesis, and can be obtained based on NZP CSI-RS (and may also include interference) measurement by each user i. The CSI report κᵢ in general includes RI, CQI, and PMI, where RI indicates a number of layers (νᵢ), PMI indicates the corresponding (SU) precoding matrix P_{SU,i}=[P_{SU,1} . . . P_{SU,ν}_{ᵢ}], and CQI indicates a channel quality qᵢ (e.g. a recommended SINR or modulation and coding scheme (MCS)). In one example, the channel for user i can be approximated at the transmitter as:

Hᵢ˜αᵢP_{SU,i}=αᵢ[P_{SU,1} . . . P_{SU,ν}_{ᵢ}],

where αᵢ is a scalar scaling factor. In one example, αᵢ=1. In one example, αᵢ=\sqrt{νᵢ}. In one example, αᵢ=νᵢ. In one example, αᵢ=\sqrt{qᵢ}. In one example, αᵢ=. In one example, αᵢ=\sqrt{νᵢqᵢ}. In one example, αᵢ=νᵢqᵢ. In one example, αᵢ=νᵢ\sqrt{qᵢ}. In one example, αᵢ=\sqrt{νᵢqᵢ}. In one example, αᵢ=(νᵢqᵢ)^{α} where α is a number between 0 and 1. In one example, αᵢ=(q₁)^{α}(νᵢ)^{b} where α and b are numbers between 0 and 1.

Embodiments of the present disclosure recognize that, while the approximation of the channel herein is reasonable for SU-MIMO transmission (since it is derived based on SU-MIMO hypothesis), it has at least the following issues/drawbacks:
Issue 1 (per-UE): νᵢ layers can't be distinguished in terms of strength/power, i.e. the scaling αᵢ applies to layers νᵢ, hence can't provide channel strengths across layers (i.e. it can't provide information about eigenvalues assuming SU precoding matrix provides some information about channel eigenvectors).
Issue 2 (across-UE): relative power levels across U users is needed for MU precoder calculation. While {αᵢ}can be used for this purpose, but it is too coarse taking into account small number of bits used for CQI (4 bits WB together with 2 bits per SB CQI, differential w.r.t. WB CQI).

Embodiments of the present disclosure provide embodiments/examples as solutions. The provided embodiments/examples are not restricted to (limited to) the MU-MIMO schemes. They are general and can be applied to several other implementations both as NW and UE sides, for instance, SU/MU scheduling, link adaptation, MCS selection, NW energy saving (NES) etc. at the NW side, and UE-assisted NW implementations in general.

The present disclosure relates to next generation communication systems (e.g. adv. 5G and 6G) based on a MIMO framework as described herein. This disclosure, in particular provides measurement and reporting to facilitate efficient SU/MU-MIMO transmission, and following are aspects of this disclosure:
Reporting of a “new” report quantity for strength/quality of a layer or layers (of a CSI report)
Example of the new report quantity and use cases
Signaling/configuration details

In the following, for brevity, both FDD and TDD are regarded as the duplex method for both DL and UL signaling.

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure covers several components which can be used in conjunction or in combination with one another, or can operate as standalone schemes.

All the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, the following components and embodiments are applicable for UL transmission when the scheduling unit in time is either one subframe (which can include one or multiple slots) or one slot.

In the present disclosure, the frequency resolution (reporting granularity) and span (reporting bandwidth) of CSI reporting can be defined in terms of frequency “subbands” and “CSI reporting band” (CRB), respectively.

A subband for CSI reporting is defined as a set of contiguous PRBs which represents the smallest frequency unit for CSI reporting. The number of PRBs in a subband can be fixed for a given value of DL system bandwidth, configured either semi-statically via higher-layer/RRC signaling, or dynamically via L1 DL control signaling or MAC control element (MAC CE). The number of PRBs in a subband can be included in CSI reporting setting.

“CSI reporting band” is defined as a set/collection of subbands, either contiguous or non-contiguous, wherein CSI reporting is performed. For example, CSI reporting band can include the subbands within the DL system bandwidth. This can also be termed “full-band”. Alternatively, CSI reporting band can include only a collection of subbands within the DL system bandwidth. This can also be termed “partial band”.

The term “CSI reporting band” is used only as an example for representing a function. Other terms such as “CSI reporting subband set” or “CSI reporting bandwidth” or bandwidth part (BWP) can also be used.

In terms of UE configuration, a UE (e.g., the UE 116) can be configured with at least one CSI reporting band. This configuration can be semi-static (via higher-layer signaling or RRC) or dynamic (via MAC CE or L1 DL control signaling). When configured with multiple (N) CSI reporting bands (e.g. via RRC signaling), a UE can report CSI associated with n≤N CSI reporting bands. For instance, >6 GHz, large system bandwidth may require multiple CSI reporting bands. The value of n can either be configured semi-statically (via higher-layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mₙ subbands when one CSI parameter for the Mₙ subbands within the CSI reporting band. A CSI parameter is configured with “subband” for the CSI reporting band with Mₙ subbands when one CSI parameter is reported for each of the Mₙ subbands within the CSI reporting band.

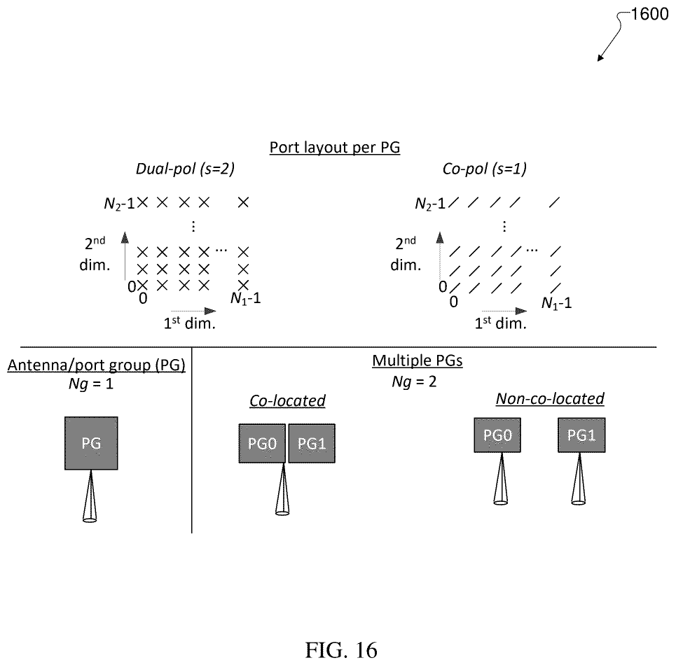

FIG. 16 illustrates example antenna port layouts 1600 according to embodiments of the present disclosure. For example, antenna port layouts 1600 can be implemented in the wireless network 100 of FIG. 1. This example is for illustration only and can be used without departing from the scope of the present disclosure.

In the following, N₁ and N₂ are the number of antenna ports with the same polarization in the first and second dimensions, respectively. For 2D antenna port layouts, N₁>1, N₂>1, and for 1D antenna port layouts either N₁>1 and N₂=1 or N₂>1 and N₁=1. In the rest of the disclosure, 1D antenna port layouts with N₁>1 and N₂=1 is provided. The disclosure, however, is applicable to the other 1D port layouts with N₂>1 and N₁=1. Also, in the rest of the disclosure, N₁≥N₂. The disclosure, however, is applicable to the case when N₁<N₂, and the embodiments for N₁>N₂ apply to the case N₁<N₂ by swapping/switching (N₁, N₂) with (N₂, N₁). For a single-polarized (or co-polarized) antenna port layout, the total number of antenna ports is P_{CSIRS}=N₁N₂. And, for a dual-polarized antenna port layout, the total number of antenna ports is P_{CSIRS}=2N₁N₂. An illustration is shown in FIG. 16 where “X” represents two antenna polarizations (dual-pol, s=2) and “/” represents one antenna polarization (co-pol, s=1). In this disclosure, the term “polarization” refers to a group of antenna ports with the same polarization. For example, antenna ports

$$j = X + 0 , X + 1 , … , X + \frac{{P}_{CSIRS}}{2} - 1$$

comprise a first antenna polarization, and antenna ports

$$j = X + \frac{{P}_{CSIRS}}{2} , X + \frac{{P}_{CSIRS}}{2} + 1 , … , X + {P}_{CSIRS} - 1$$

comprise a second antenna polarization, where P_{CSIRS} is a number of CSI-RS antenna ports and X is a starting antenna port number (e.g. X=3000, then antenna ports are 3000, 3001, 3002, . . . ). Unless stated otherwise, dual-polarized antenna layouts are provided in this disclosure. The embodiments (and examples) in this disclosure however are general and are applicable to single-polarized antenna layouts as well.

Let s denotes the number of antenna polarizations (or groups of antenna ports with the same polarization). Then, for co-polarized antenna ports, s=1, and for dual- or cross (X)-polarized antenna ports s=2. So, the total number of antenna ports P_{CSIRS}=sN₁N₂.

Let N_{g} be a number of antenna/port groups (PGs). When there are multiple antenna/port groups (N_{g}>1), each group (g∈{1, . . . , N_{g}}) comprises N_{1,g} and N_{2,g} ports in two dimensions. This is illustrated in FIG. 16. Note that the antenna port layouts may be the same (N_{1,g}=N₁ and N_{2,g}=N₂) in different antenna/port groups, or they can be different across antenna/port groups. For group g, the number of antenna ports is P_{CSIRS,g}=N_{1,g} N_{2,g} or 2N_{1,g}N_{2,g} (for co-polarized or dual-polarized respectively), i.e., P_{CSIRS,g}=s_{g}N_{1,g}N_{2,g} where s_{g}=1 or 2.

In one example, an antenna/port group corresponds to an antenna panel. In one example, an antenna/port group corresponds to a TRP. In one example, an antenna/port group corresponds to an RRH. In one example, an antenna/port group corresponds to CSI-RS antenna ports of a NZP CSI-RS resource. In one example, an antenna/port group corresponds to a subset of CSI-RS antenna ports of a NZP CSI-RS resource (comprising multiple antenna/port groups). In one example, an antenna/port group corresponds to CSI-RS antenna ports of multiple NZP CSI-RS resources (e.g. comprising a CSI-RS resource set).

In one example, an antenna/port group corresponds to a reconfigurable intelligent surface (RIS) in which the antenna/port group can be (re-)configured more dynamically (e.g. via MAC CE or/and DCI). For example, the number of antenna ports associated with the antenna/port group can be changed dynamically.

In one example, the antenna architecture of the MIMO system is structured. For example, the antenna structure at each PG or O-RU (or RU) is dual-polarized (single or multi-panel) as shown in FIG. 16. The antenna structure at each PG or O-RU (or RU) can be the same. Or the antenna structure at an PG or O-RU (or RU) can be different from another PG or O-RU (or RU). Likewise, the number of ports at each PG (or O-RU or RU) can be the same. Or the number of ports at one PG (or O-RU or RU) can be different from another PG (or O-RU or RU).

In another example, the antenna architecture of the MIMO system is unstructured. For example, the antenna structure at one PG (or O-RU or RU) can be different from another PG (or O-RU or RU).

A structured antenna architecture is expected in the rest of the disclosure. For simplicity, each PG (or O-RU or RU) is equivalent to a panel (cf. FIG. 16), although, an PG (or O-RU or RU) can have multiple panels in practice. The disclosure however is not restrictive to a single panel assumption at each PG (or O-RU or RU), and can easily be extended (covers) the case when an PG (or O-RU or RU) has multiple antenna panels.

In one embodiment, an PG (or O-RU or RU) constitutes (or corresponds to or is equivalent to) at least one of the following:
In one example, an PG or O-RU (or RU) corresponds to a TRP.
In one example, an PG or O-RU (or RU) corresponds to a CSI-RS resource. A UE is configured with K=N_{g}>1 non-zero-power (NZP) CSI-RS resources, and a CSI reporting is configured to be across multiple CSI-RS resources. This is similar to Class B, K>1 configuration in Rel. 14 LTE. The K NZP CSI-RS resources can belong to a CSI-RS resource set or multiple CSI-RS resource sets (e.g. K resource sets each comprising one CSI-RS resource). The details are as explained herein.
In one example, an PG or O-RU (or RU) corresponds to a CSI-RS resource group, where a group comprises one or multiple NZP CSI-RS resources. A UE is configured with K≥N_{g}>1 non-zero-power (NZP) CSI-RS resources, and a CSI reporting is configured to be across multiple CSI-RS resources from resource groups. This is similar to Class B, K>1 configuration in Rel. 14 LTE. The K NZP CSI-RS resources can belong to a CSI-RS resource set or multiple CSI-RS resource sets (e.g. K resource sets each comprising one CSI-RS resource). The details are as explained herein. In particular, the K CSI-RS resources can be partitioned into N_{g} resource groups. The information about the resource grouping can be provided together with the CSI-RS resource setting/configuration, or with the CSI reporting setting/configuration, or with the CSI-RS resource configuration.
In one example, an PG or O-RU (or RU) corresponds to a subset (or a group) of CSI-RS ports. A UE is configured with at least one NZP CSI-RS resource comprising (or associated with) CSI-RS ports that can be grouped (or partitioned) multiple subsets/groups/parts of antenna ports, each corresponding to (or constituting) an PG or O-RU (or RU). The information about the subsets of ports or grouping of ports can be provided together with the CSI-RS resource setting/configuration, or with the CSI reporting setting/configuration, or with the CSI-RS resource configuration.
In one example, an PG or O-RU (or RU) corresponds to one or more examples described herein depending on a configuration. For example, this configuration can be explicit via a parameter (e.g. an RRC parameter). Or it can be implicit.
   In one example, when implicit, it could be based on the value of K. For example, when K>1 CSI-RS resources, an PG or O-RU (or RU) corresponds to one or more examples described herein, and when K=1 CSI-RS resource, an PG or O-RU (or RU) corresponds to one or more examples described herein.
   In another example, the configuration could be based on the configured codebook. For example, an PG or O-RU (or RU) corresponds to a CSI-RS resource (according to one or more examples described herein) or resource group (according to one or more examples described herein) when the codebook corresponds to a decoupled codebook (modular or separate codebook for each PG or O-RU (or RU)), and an PG or O-RU (or RU) corresponds to a subset (or a group) of CSI-RS ports (according to one or more examples described herein) when codebook corresponds to a coupled (joint or coherent) codebook (one joint codebook across PGs).

In one example, when PG or O-RU (or RU) maps (or corresponds to) a CSI-RS resource or resource group (according to one or more examples described herein), and a UE can select a subset of PGs (resources or resource groups) and report the CSI for the selected PGs (resources or resource groups), the selected PGs can be reported via an indicator. For example, the indicator can be a CRI or a PMI (component) or a new indicator.

In one example, when PG or O-RU (or RU) maps (or corresponds to) a CSI-RS port group (according to one or more examples described herein), and a UE can select a subset of PGs (port groups) and report the CSI for the selected PGs (port groups), the selected PGs can be reported via an indicator. For example, the indicator can be a CRI or a PMI (component) or a new indicator.

In one example, when multiple (K>1) CSI-RS resources are configured for N_{g} PGs (according to one or more examples described herein), a decoupled (modular) codebook is used/configured, and when a single (K=1) CSI-RS resource for N_{g} PGs (according to one or more examples described herein), a joint codebook is used/configured.

In the following and throughout the disclosure, various embodiments of the disclosure may be also implemented in any type of UE including, for example, UEs with the same, similar, or more capabilities compared to 5G NR UEs. Although various embodiments of the disclosure discuss 3GPP 5G NR communication systems, the embodiments may apply in general to UEs operating with other RATs and/or standards, such as next releases/generations of 3GPP, IEEE WiFi, and so on.

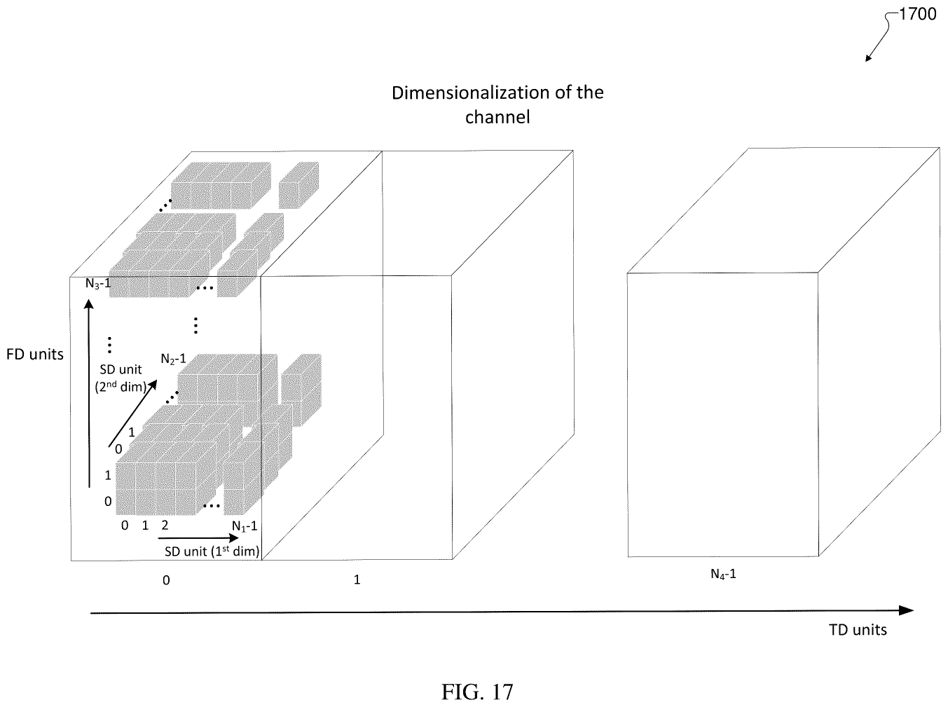

FIG. 17 illustrates a timeline 1700 of example SD units and FD units according to embodiments of the present disclosure. For example, timeline 1700 can be followed by any of the UEs 111-116 of FIG. 1, such as the UE 111. This example is for illustration only and other embodiments can be used without departing from the scope of the present disclosure.

In one embodiment, a UE is configured (e.g. via a higher layer CSI configuration information) with a CSI report, where the CSI report is based on a channel measurement (and interference measurement) and a codebook. When the CSI report is configured to be aperiodic, it is reported when triggered via a DCI field (e.g. a CSI request field) in a DCI.

The channel measurement can be based on K≥1 channel measurement resources (CMRs) that are transmitted from a plurality of spatial-domain (SD) units (e.g. a SD unit=a CSI-RS antenna port), and are measured via a plurality of frequency-domain (FD) units (e.g. a FD unit=one or more PRBs/SBs) and via either a time-domain (TD) unit or a plurality of TD units (e.g. a TD unit=one or more time slots). In one example, a CMR can be a NZP-CSI-RS resource.

The CSI report can be associated with the plurality of FD units and the plurality of TD units associated with the channel measurement. Alternatively, the CSI report can be associated with a second set of FD units (different from the plurality of FD units associated with the channel measurement) or/and a second set of TD units (different from the plurality of TD units associated with the channel measurement). In this later case, the UE, based on the channel measurement, can perform prediction (interpolation or extrapolation) in the second set of FD units or/and the second set of TD units associated with the CSI report.

An illustration of the SD units (in 1^{st} and 2^{nd} antenna dimensions), FD units, and TD units is shown in FIG. 17.
The first dimension is associated with the 1st antenna port dimension and comprises N₁ units,
The second dimension is associated with the 2nd antenna port dimension and comprises N₂ units,
The third dimension is associated with the frequency dimension and comprises N₃ units, and
The fourth dimension is associated with the time/Doppler dimension and comprises N₄ units.

Alternatively, the SD units, FD units, and TD units are as follows.
The first dimension is associated with the antenna port dimension and comprises P_{CSIRS} units,
The second dimension is associated with the frequency dimension and comprises N₃ units, and
The third dimension is associated with the time/Doppler dimension and comprises N₄ units.

The plurality of SD units can be associated with antenna ports (e.g. co-located at one site or distributed across multiple sites) comprising one or multiple antenna/port groups (i.e., N_{g}≥1), and dimensionalizes the spatial-domain profile of the channel measurement.

When K=1, there is one CMR comprising P_{CSIRS} CSI-RS antenna ports.
When N_{g}=1, there is one PG comprising P_{CSIRS} ports, and the CSI report is based on the channel measurement from the one PG.
When N_{g}>1, there are multiple PGs, and the CSI report is based on the channel measurement from/across the multiple PGs.

When K>1, there are multiple CMRs, and the CSI report is based on the channel measurement across the multiple CMRs. In one example, a CMR corresponds to an PG (one-to-one mapping). In one example, multiple CMRs can correspond to an PG (many-to-one mapping).

In one example, when the P_{CSIRS} antenna ports are co-located at one site, N_{g}=1. In one example, when the P_{CSIRS} antenna ports are distributed (non-co-located) across multiple sites, N_{g}>1.

In one example, when the P_{CSIRS} antenna ports are co-located at one site and within a single antenna panel, N_{g}=1. In one example, when the P_{CSIRS} antenna ports are distributed across multiple antenna panels (can be co-located or non-co-located), N_{g}>1.

The value of N_{g} can be configured, e.g. via higher layer RRC parameter. Or it can be indicated via a MAC CE. Or it can be provided via a DCI field.

Likewise, the value of K can be configured, e.g. via higher layer RRC parameter. Or it can be indicated via a MAC CE. Or it can be provided via a DCI field.

In one example, K=N_{g}=X. The value of X can be configured, e.g. via higher layer RRC parameter. Or it can be indicated via a MAC CE. Or it can be provided via a DCI field.

In one example, the value of K is determined based on the value of N_{g}. In one example, the value of N_{g} is determined based on the value of K.

The plurality of FD units can be associated with a frequency domain allocation of resources (e.g. one or multiple CSI reporting bands, each comprising multiple PRBs) and dimensionalizes the frequency (or delay)-domain profile of the channel measurement.

The plurality of TD units can be associated with a time domain allocation of resources (e.g. one or multiple CSI reporting windows, each comprising multiple time slots) and dimensionalizes the time (or Doppler)-domain profile of the channel measurement.

In one example, the number of antenna ports across K CSI-RS resources is the same. For example, each of the K CSI-RS resources can be associated with 2N₁N₂ antenna ports. In this case, the total number of antenna ports is P_{CSIRS,tot}=2KN₁N₂.

In one example, the number of antenna ports across K CSI-RS resources can be the same or different. For example, each of the K CSI-RS resources can be associated with 2N_{1,r}N_{2,r} antenna ports. In this case, the total number of antenna ports is

$${P}_{CSIRS , tot} = {\sum }_{r = 1}^{K} 2 {N}_{1 , r} {N}_{2 , r} .$$

In port numbering scheme 1, the CSI-RS ports are numbered according to the order of (polarization p, NZP CSI-RS resource r) as CSI-RS ports of (p=0, r=1) followed by CSI-RS ports of (p=1,r=1), followed by CSI-RS ports of (p=0,r=2), followed by CSI-RS ports of (p=1, r=2), . . . , followed by CSI-RS ports of (p=0, r=N) followed by CSI-RS ports of (p=1,r=N).

In port numbering scheme 2, the CSI-RS ports are numbered according to the order of (polarization p, NZP CSI-RS resource r) as
CSI-RS ports of (p=0, r=1) followed by CSI-RS ports of (p=0, r=1), . . . , followed by CSI-RS ports of (p=0, r=N), and
then CSI-RS ports of (p=1,r=1) followed by CSI-RS ports of (p=1,r=1), . . . , followed by CSI-RS ports of (p=1, r=N).

In one example, an PG corresponds to an antenna, an antenna group (multiple antennae), an antenna port, an antenna port group (multiple ports), a CSI-RS resource, a CSI-RS resource set, a group of CSI-RS resources, a panel, an RRH, a Tx-Rx entity, a (analog) beam, a (analog) beam group, a cell, a cell group.

In one example, PGs can have a uniform (the same/common) structure. For example, they can have the same number of ports (P_{CSIRS,r}=P_{CSIRS}) or the same antenna port layout (N_{1,r}, N_{2,r})=(N₁, N₂). In one example, PGs can have non-uniform (or different) structure. For example, they can have the same or different number of ports (P_{CSIRS,r}_{₁}=P_{CSIR}S,r₂ or P_{CSIRS,r}_{₁}≠P_{CSIRS,r}_{₂}) or the same antenna port layout, i.e., (N_{1,r}_{₁}, N_{2,r}_{₁})=(N_{1,r}_{₂}, N_{2,r}_{₂}) or (N_{1,r}_{₁}, N_{2,r}_{₁})≠(N_{1,r}_{₂}, N_{2,r}_{₂}).

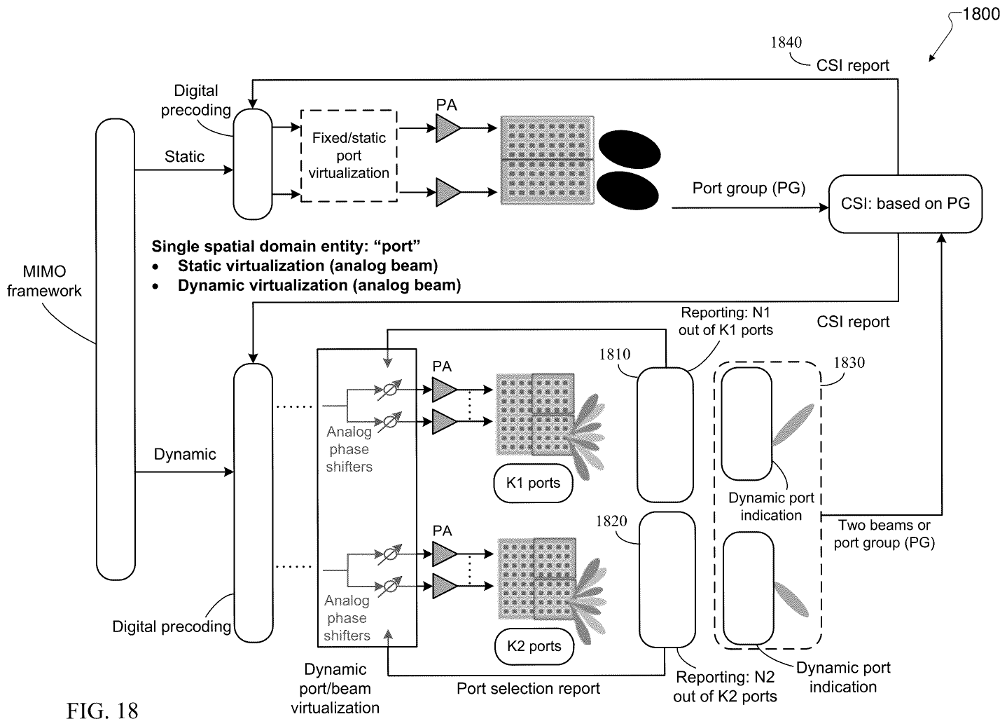

FIG. 18 illustrates an example PG 1800 according to embodiments of the present disclosure. For example, PG 1800 can be implemented in the BS 102 of FIG. 1. This example is for illustration only and other embodiments can be used without departing from the scope of the present disclosure.

For the purpose of DL CSI acquisition, when necessary, a port group (PG) can be defined as a collection of N_{b}≥1 ports sharing a commonly configured set of properties (analogous to CSI-RS resource in 5G NR). This is instrumental in CSI reporting utilized for mTRP or multiple O-RUs (especially CJT) or virtual sectorization where a TRP or a O-RU or a virtual sector corresponds to a PG. Three key components of the framework are shown in FIG. 18.
C1: measurement and reporting 1810 and 1820 to facilitate port selection/indication,
C2: dynamic indication 1830 of N port(s) out of K ports, and
C3: CSI reporting 1840 to enable digital precoding across a UE-recommended port group (PG).

In FR2 (i.e. in case of dynamic virtualization via analog beam), C1-C3 are utilized, and in FR1/FR3 (i.e., in case of fixed virtualization), only C3 is utilized. In the following, a PG is defined for FR1/FR3 (fixed virtualization case), not for FR2. In one example, PG is defined regardless of frequency band. An example FR1-FR3 are shown in Table 3.

TABLE 3

| Frequency range | Band |
|---|---|
| FR1 | Low band (<1 GHz) |
| FR1/FR3 | Lower mid band (1~7 GHz) |
| FR3 | Upper mid band (7~24) |
| FR2 | mmWave (>24 GHz) |

In one embodiment, a UE (e.g., the UE 116) is configured with a CSI report (e.g. trigger state or a CSI report setting via higher layer IE CSI-AperiodicTriggerState or CSI-ReportConfig) based on a port-based/PG-based framework, wherein the CSI report is based on a measurement configuration (e.g. CSI-ResourceConfig or CSI-MeasurementConfig or CSI-PGConfig or CSI-PortConfig).

The measurement configuration includes a configuration for channel measurement, which can be according to one of the following examples.
In one example, the channel measurement corresponds to measuring P_{CSIRS} CSI-RS ports.
In one example, the channel measurement corresponds to measuring N_{g}≥1 PGs, where a PG g=1 . . . , N_{g} includes P_{CSIRS,r} CSI-RS ports.
In one example, the channel measurement corresponds to measuring the Q_{CSIRS} ports or Mg PGs indicated dynamically (E.g. via DCI or/and MAC CE), where the Q_{CSIRS} ports or Mg PGs respectively are from the configured the P_{CSIRS} ports or N_{g} PGs. The dynamic indication can facilitate turning ports or PGs ON/OFF (e.g. for energy saving purpose).

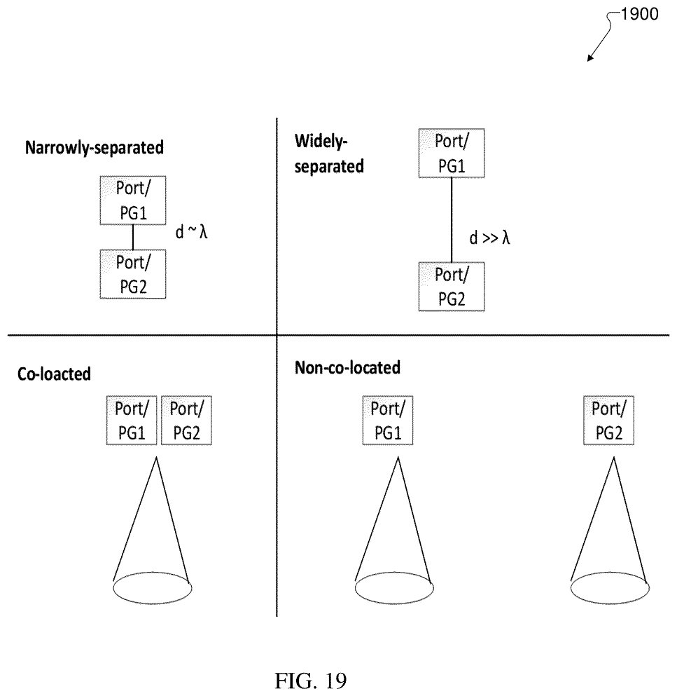

FIG. 19 illustrates examples of narrow/wide and co-located/non-co-located ports/PGs 1900 according to embodiments of the present disclosure. For example, narrow/wide and co-located/non-co-located ports/PGs 1900 can be implemented in the BS 102 of FIG. 1. This example is for illustration only and other embodiments can be used without departing from the scope of the present disclosure.

As shown in FIG. 19, the ports/PGs can be narrowly-spaced or widely-spaced with compared with the wavelength A of the (center) carrier of the frequency band associated with the CSI report. Or, the ports/PGs can be col-located (at physical location) or non-co-located (at different physical locations).

The measurement configuration can also include a configuration for interference measurement.
In one example, the interference measurement corresponds to measuring I_{1MR} CSI-IMR ports. In one example, I_{1MR}=P_{CSIRS}. In one example, I_{1MR}=1.
In one example, the interference measurement corresponds to measuring I_{g}≥1 PGs, where a PG r=1 . . . , I_{g} includes I_{1MR,r} CSI-IMR ports. In one example, I_{g}=N_{g}. In one example, I_{g}=1. In one example, I_{1MR,r}=P_{CSIRS,r}. In one example, I_{1MR,r}=1.

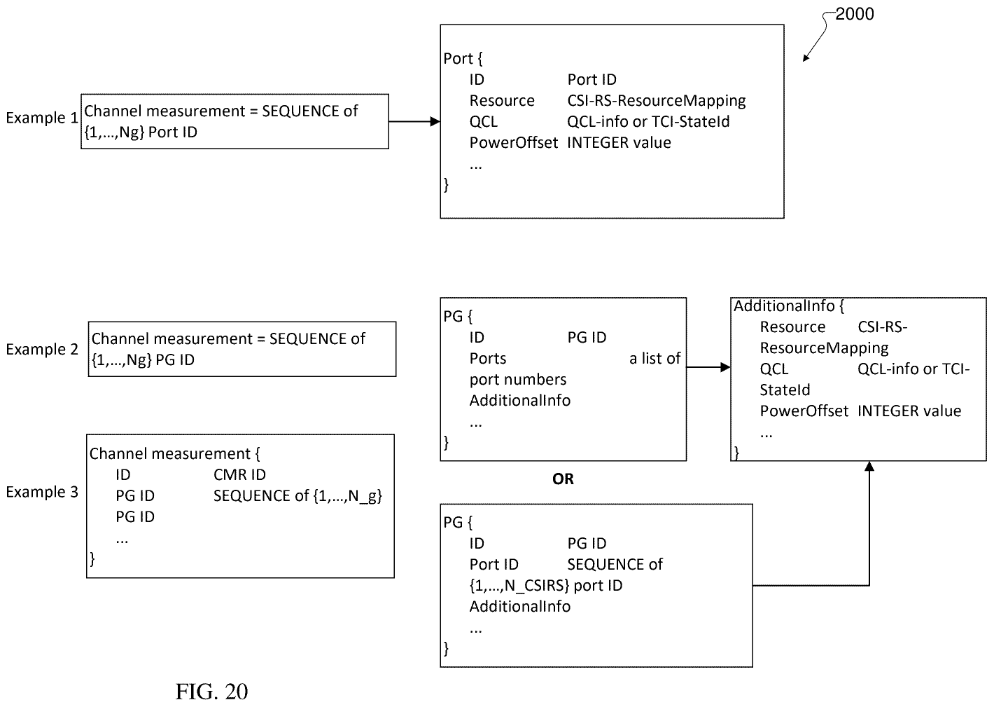

FIG. 20 illustrates examples of channel measurement configurations 2000 according to embodiments of the present disclosure. For example, the BS 102 of FIG. 2 can configure channel measurement configurations 2000. This example is for illustration only and other embodiments can be used without departing from the scope of the present disclosure.

In one example, a configuration for channel measurement includes at least one of the following:
In one example, a configuration for channel measurement includes a list (or sequence) of port IDs, where a port ID indicates an information (e.g. IE) about a port for measurement. Example 1 in FIG. 20 is an example.
In one example, a configuration for channel measurement includes an ID of a PG (e.g. PG ID) or a sequence of N_{g}≥1 IDs (e.g. each is a PG ID). Example 2 and 3 in FIG. 20 are two examples.
In one example, a configuration for channel measurement includes a list of port numbers (e.g. for CSI-RS, port numbers are from {3000, 3001, 3002, . . . }).

In one example, the UE receives a trigger message (e.g. which indicates a CSI-TriggerState) for aperiodic (AP) reporting of the CSI report. In one example, the trigger message is received via a DCI (e.g. CSI request field in an UL-related DCI or a CSI request field in a DL-related DCI or a CSI request field in a dedicated or special purpose DCI that is different from DL-related DCI or UL-related DCI). Here, DCI-related DCI corresponds to a DCI (format) that allocates DL PDSCH assignment, and UL-related DCI corresponds to a DCI (format) that grants UL PUSCH transmission.

In one example, the UE initiates/triggers the measurement/reporting by transmitting a message/request to the NW. The message/request acts as a trigger (e.g. which indicates a CSI-TriggerState) for the AP reporting of the CSI report. In one example, the message/request is via a layer 1 signaling such as scheduling request (SR) or UCI. In this example, higher layer RRC (or/and MAC CE) is used to configure (and activate) one or more than one AP CSI trigger states, and SR/UCI with the message/request acts as a trigger (without any indication from NW). The UL resource allocation (RA) for CSI report can be pre-configured (CG PUSCH), or granted after the UE-initiated trigger/request is received.

In one example, the UE initiates/triggers the measurement/reporting by transmitting a message/request to the NW. The message/request acts as a trigger (e.g. which indicates a CSI-TriggerState) for the AP reporting of the CSI report. The UE then receives an ACK (e.g. 1-bit in DCI), and then performs measurement and reporting of the CSI report. In one example, the message/request is via a layer 1 signaling such as scheduling request (SR) or UCI. In this example, higher layer RRC (or/and MAC CE) is used to configure (and activate) one or more than one AP CSI trigger states, and SR/UCI with the message/request acts as a trigger or activator and the ACK from the NW allows/initiates the CSI reporting procedure. The UL resource allocation (RA) for CSI report can be pre-configured (CG PUSCH), or granted (e.g. together with ACK).

In a variation of the previous example, a first DCI (as explained herein) can dynamically change/adapt information about the measurement (e.g. number of ports, power level etc.) associated with the CSI report, but does not trigger the CSI report. The trigger is UE-initiated. The NW can ACK in response to the UE-initiated trigger/request via a second DCI, and then the UE measures and reports the CSI report according to the latest update (if any) of the CSI Trigger state (via the first DCI). In one example, the first DCI and the second DCI are the same. In one example, they can be different.

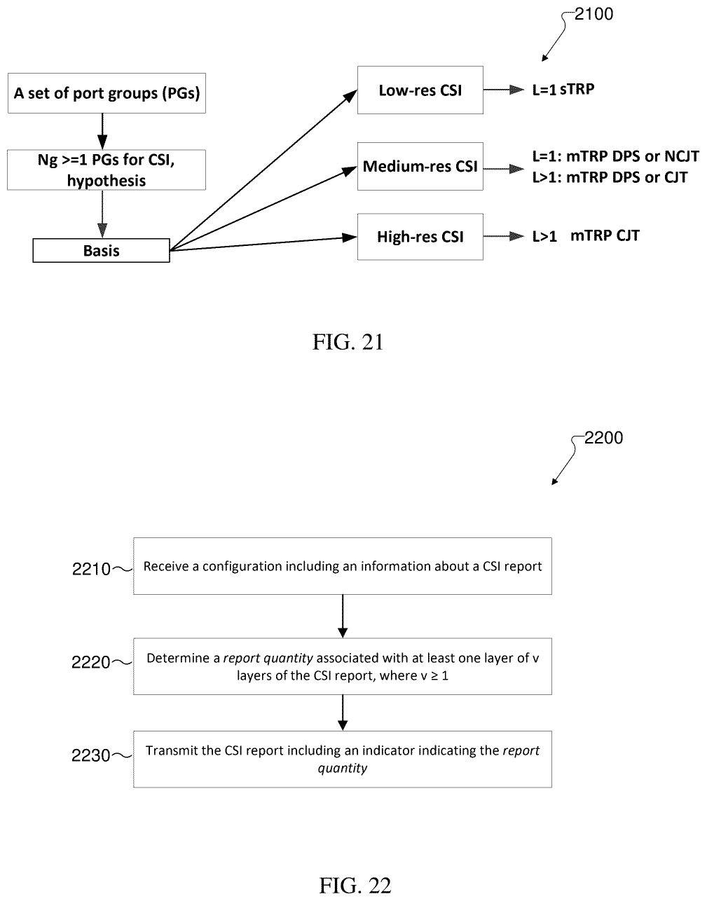

FIG. 21 illustrates an example a codebook configuration 2100 according to embodiments of the present disclosure. For example, the BS 103 can configure codebook configuration 2100. This example is for illustration only and other embodiments can be used without departing from the scope of the present disclosure.

In one embodiment, the UE is further configured with a codebook for PMI calculation and reporting, where the codebook includes at least two components; (a) basis and (b) coefficients, as shown in FIG. 21. The basis includes L vectors (or matrices) associated with SD (across SD units such as ports or/and PGs). Additionally, the basis can also include M vectors (or matrices) associated with FD (across FD units such as PRBs or SBs), or/and Q vectors (or matrices) associated with TD/DD (across TD/division duplexing (DD) units such as time slots). The parameter (L, M, Q) can be fixed or configured (e.g. via higher layer parameter).

In one example, when L=1, the codebook corresponds to a low-resolution codebook based on a single vector, and when L>1, the codebook corresponds to a high-resolution codebook based on a linear combination of multiple vectors.

When M is not provided/configured, there is no FD basis, i.e., there is no compression in FD, and hence the PMI component (i₂) for the co-phase or/and amplitude of the coefficients are reported for each SB in the CSI reporting band. When M is provided, there is FD compression across FD PRBs (cf. Rel-16 eType II codebook in 5G NR).

When Q is not provided/configured, there is no TD/DD basis, i.e., there is no compression in TD/DD. When Q is provided, there is TD/DD compression across TD/DD units or time slots (cf. Rel-18 eType II-Doppler codebook in 5G NR).

In one example, the basis vectors are DFT vectors. In one example, the basis vectors are orthogonal DFT vectors without oversampling or rotation factor (i.e. the DFT vectors are critically sampled, i.e. oversampling factor=1). In one example, the basis vectors are orthogonal DFT vectors with oversampling or rotation factor (i.e. the DFT vectors are oversampled with oversampling factor>1, e.g. 4). In one example, the SD basis vectors are orthogonal DFT vectors with oversampling or rotation factor=4. In one example, the FD or DD/TD basis vectors are orthogonal DFT vectors without oversampling or rotation factor.

In one example, when number of layers>1, precoder for each layer is calculated independently.

In one example, the structure of the precoding matrix is given by summation over up to three basis vectors:

$$p = {\sum }_{i = 0}^{L - 1} {\sum }_{f = 0}^{M - 1} {\sum }_{d = 0}^{Q - 1} {B}_{i , f , d} \times {c}_{i , f , d} or$$

$$[ \begin{matrix}{\sum }_{i = 0}^{L - 1} {\sum }_{f = 0}^{M - 1} {\sum }_{d = 0}^{Q - 1} {B}_{i , f , d} \times {c}_{i , f , d} \\ {\sum }_{i = 0}^{L - 1} {\sum }_{f = 0}^{M - 1} {\sum }_{d = 0}^{Q - 1} {B}_{i + L , f , d} \times {c}_{i + L , f , d}\end{matrix} ]$$

where B_{i,f,d} indicates a (i, f, d)-the element of the basis in three dimension, and C_{j,f,d} is the corresponding coefficient.

When there is no DD/TD compression, then

$$p = {\sum }_{i = 0}^{L - 1} {\sum }_{f = 0}^{M - 1} {B}_{i , f} \times {c}_{i , f} or$$

$$[ \begin{matrix}{\sum }_{i = 0}^{L - 1} {\sum }_{d = 0}^{Q - 1} {B}_{i , f} \times {c}_{i , f} \\ {\sum }_{i = 0}^{L - 1} {\sum }_{f = 0}^{M - 1} {B}_{i + L , f} \times {c}_{i + L , f}\end{matrix} ] .$$

When there is no FD compression, then

$$p = {\sum }_{i = 0}^{L - 1} {\sum }_{d = 0}^{Q - 1} {B}_{i , d} \times {c}_{i , d} or$$

$$[ \begin{matrix}{\sum }_{i = 0}^{L - 1} {\sum }_{d = 0}^{Q - 1} {B}_{i , d} \times {c}_{i , d} \\ {\sum }_{i = 0}^{L - 1} {\sum }_{d = 0}^{Q - 1} {B}_{i + L , d} \times {c}_{i + L , d}\end{matrix} ] .$$

When there is no FD and DD/TD compression, then

$$p = {\sum }_{i = 0}^{L - 1} {B}_{i} \times {c}_{i} or$$

$$[ \begin{matrix}{\sum }_{i = 0}^{L - 1} {B}_{i} \times {c}_{i} \\ {\sum }_{i = 0}^{L - 1} {B}_{i + L} \times {c}_{i + L}\end{matrix} ] .$$

In one example, B_{i+L}=Bᵢ.

FIG. 22 illustrates a flowchart of an example UE procedure 2200 for determining a report quantity according to embodiments of the present disclosure. For example, procedure 2200 can be performed by any of the UEs 111-116 of FIG. 1, such as the UE 112. This example is for illustration only and other embodiments can be used without departing from the scope of the present disclosure.

The procedure begins in 2210, a UE receives a configuration including an information about a CSI report. In 2220, the UE determines a report quantity associated with at least one layer of v layers of the CSI report, where v≥1. In 2230, the UE transmits the CSI report including an indicator indicating the report quantity.

In one embodiment, as shown in FIG. 22, a UE receives a configuration (e.g. an RRC message, IE, or parameter, or/and a DCI trigger or codepoint) and in response, determines a report quantity associated with at least one layer of a total of ν≥1 layers of a report (e.g. a CSI report as described in this disclosure), where the report includes an indicator indicating the determined report quantity, denoted herein as q. The quantity q provides an information about the strength/quality of the at least one layer. In one example, a layer corresponds to a column of the precoding matrix indicated via the PMI, wherein the PMI can be included in the report (for instance, the report may include RI, CQI, and PMI, and also CRI and LI optionally). The quantity q therefore can provide information about the strength/quality of layers corresponding to columns of the precoding matrix.

In a first use case, the NW/gNB (e.g., the network 130/the BS 102), upon reception, can utilize the quantity q to improve SU/MU scheduling and MU-MIMO precoder calculation. For instance, the quantity q can be utilized to address the two issues (Issue 1 and 2) mentioned herein regarding the scaling factor αᵢ. In particular, for SU scheduling, the quantity q can be utilized to distinguish SU layers of a user (addressing Issue 1), and for MU scheduling, the quantity q can be utilized to distinguish layers across users and to improve the accuracy/performance of MU-MIMO precoder schemes (addressing Issue 2).

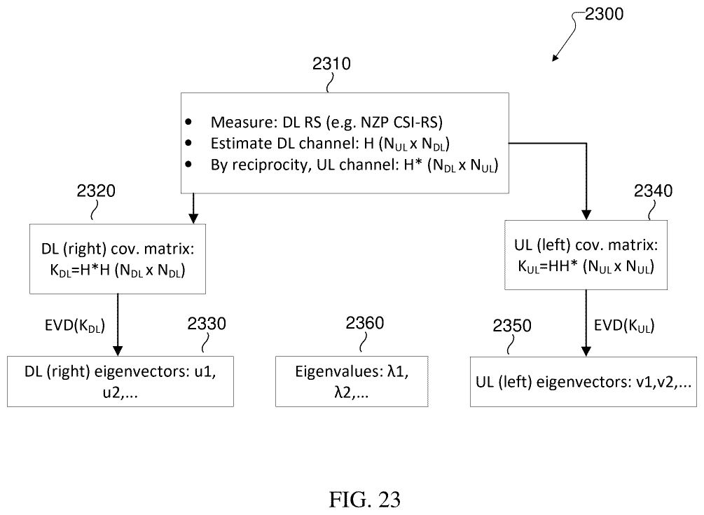

FIG. 23 illustrates a flow diagram of an example procedure 2300 for measuring/estimating UL/DL channel(s) according to embodiments of the present disclosure. For example, procedure 2300 can be performed by the UE 116 of FIG. 3. This example is for illustration only and other embodiments can be used without departing from the scope of the present disclosure.

The procedure begins in 2310, a UE measures the DL RS, estimates the DL channel H (N_{UL}×N_{DL}), and by reciprocity estimates the UL channel H*(N_{UL}×N_{DL}). In 2320, the UE determines DL (right) cov. Matrix: K_{DL}=H*H(N_{DL}×N_{DL}). In 2330, the UE determines DL (right) eigenvectors u₁, u₂, . . . . In 2340, the UE determines UL (left) cov. Matrix: K_{UL}=HH*(N_{UL}×N_{UL}). In 2350, the UE determines UL (left) eigenvectors ν₁, ν₂, . . . . In 2360, the UE determines Eigenvalues λ₁, λ₂, . . . .

In a second use case, when DL and UL channels are reciprocal (e.g. in TDD scenarios), the NW/gNB, upon reception, can utilize the quantity q to improve/adapt/determine UL link adaptation (e.g. UL SNR or SINR for UL MCS selection) for an upcoming UL transmission (e.g. UL-grant for PUSCH transmission). This is due to the fact that the layer quality/strength of a layer can be applied to (or associated with) either DL layer or UL layer. For instance, as shown in FIG. 23, a UE can be configured to receive a DL RS (e.g. NZP CSI-RS) for measurement, and in response, the UE measures the DL RS, estimates the DL channel H based on the measurement, and assuming DL and UL channel reciprocity estimates UL channel as H^{H} (Hermitian or conjugate transpose of matrix H). Based on the DL channel H, the UE can also determine the following:
(right or transmit) eigenvectors u₁,u₂, . . .
(left or receive) eigenvectors ν₁, ν₂, . . .
Eigenvalues λ₁, λ₂, . . .

When DL and UL channels are reciprocity, based on the UL channel H^{H}, the UE can also determine the following:
(left or receive) eigenvectors u₁,u₂, . . .
(right or transmit) eigenvectors ν₁, ν₂, . . .
Eigenvalues λ₁, λ₂, . . .

Since right or transmit eigenvectors can be used to pre-code,
for DL precoding, eigenvectors u₁, u₂, . . . can be used, and
for UL precoding, eigenvectors ν₁, ν₂, . . . can be used.

Note that the strength or quality of a l-th DL or UL layer can be determined based on the corresponding value λₗ.

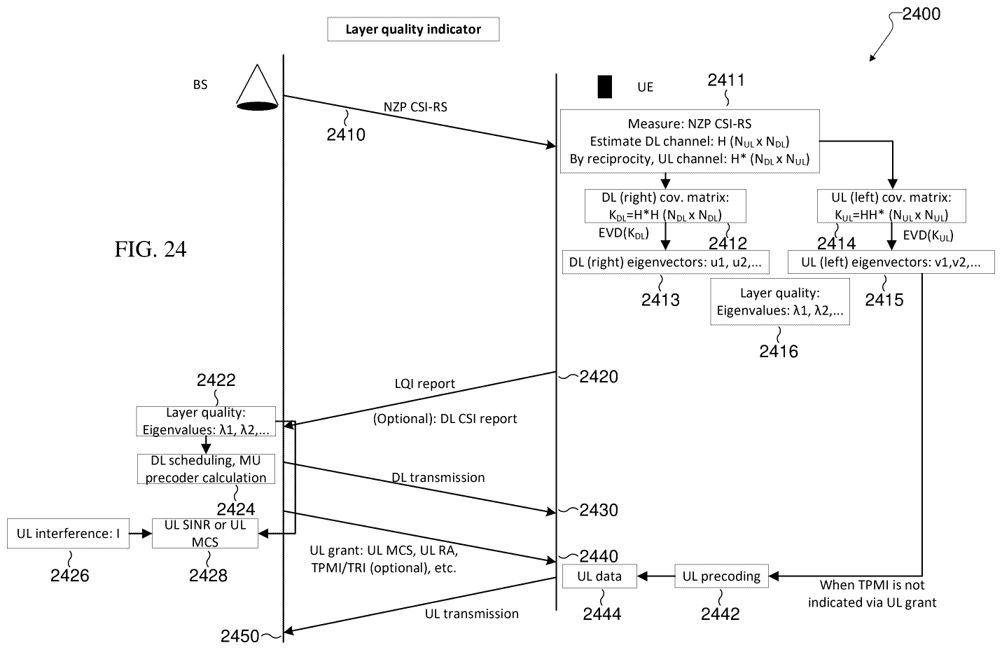

FIG. 24 illustrates a signal flow of an example procedure 2400 for indicating layer quality according to embodiments of the present disclosure. For example, procedure 2400 can be performed by the UE 116 and the gNB 102 and/or network 130 in the wireless network 100 of FIG. 1. This example is for illustration only and other embodiments can be used without departing from the scope of the present disclosure.

The procedure begins in 2410, a BS transmits a NZP CSI-RS to a UE. In 2411, the UE measures NZP CSI-RS, estimates the DL channel H (N_{UL}×N_{DL}), and by reciprocity estimates the UL channel H*(N_{UL}×N_{DL}). In 2412, the UE determines DL (right) cov. Matrix: K_{DL}=H*H(N_{DL}×N_{DL}). In 2413, the UE determines DL (right) eigenvectors u₁,u₂, . . . . In 2414, the UE determines UL (left) cov. Matrix: K_{UL}=HH*(N_{UL}×N_{UL}). In 2415, the UE determines UL (left) eigenvectors ν₁, ν₂, . . . . In 2416, the UE determines layer quality: Eigenvalues λ₁, λ₂, . . . In 2420, the UE transmits a layer quality indicator (LQI) report and a (optional) DL CSI report. In 2422, the BS is provided layer quality: Eigenvalues λ₁, λ₂, . . . In 2424, the BS performs DL scheduling MU precoder calculation. In 2426, the BS provides UL interference: I. In 2428, the BS provides UL SINR or UL MCS. In 2430, the BS transmits a DL transmission to the UE. In 2440, the BS transmits an UL grant: UL MCS, UL RA, transmit precoding matrix indicator (TPMI)/transmission rank indicator (TRI) (optional), etc. to the UE. When TPMI is not indicated via UL grant, in 2442, the UE performs UL precoding. In 2444, the UE provides UL data. In 2450, the UE transmits an UL transmission to the BS.

An illustration of utilizing layer quality report for the two use cases (mentioned herein) is shown in FIG. 24. As shown, the UE based on the DL RS measurement can determine DL (right) and UL (left) eigenvectors and corresponding eigenvalues {(uₗ, νₗ,λₗ)}, report LQI indicating (quantized) eigenvalues {λₗ} or an information about them. The UE can also include DL CSI (e.g. RI, CQI, PMI) in the report. NW/gNB upon receiving the LQI can determine the layer quality, and apply/utilize it for (a) DL scheduling or/and MU precoding calculation for subsequent DL transmission(s), or (b) UL MCS selection to be indicated via an UL-grant for subsequent UL transmission(s). The UL-grant includes UL resource allocation (UL RA), and may optionally include at least one of UL rank (TRI) and UL precoding (TPMI). When TPMI is not included in the UL-grant, the UE can use the determined UL (left) eigenvectors {νᵢ} for UL precoding. When TRI is not included in the UL-grant, the UL rank can be fixed (e.g. 1), or configured via higher layer (e.g. via PUSCH-Config).

In one example, the report quantity q corresponds to or associated with (or provides information about) equal/unequal power across layers.
In one example, the report quantity q corresponds to or associated with (or provides information about) quality of each layer, i.e., the indicator indicates ν≥1 values, one for each of ν layers.
In one example, the report quantity q corresponds to or associated with (or provides information about) quality of each CW (of the transport block, TB), i.e., the indicator indicates one value for each CW. When there are multiple layers associated with (mapped to) a CW, the corresponding value applies to the multiple layers. The mapping of layers to CWs can be fixed, or configured (e.g. via RRC or/and DCI) or reported by the UE (e.g. via CSI report over UCI or/and UE capability report). The number of value(s) included in the report quantity q can be fixed (e.g. 1 or ν or number of CWs), or configured (e.g. via RRC or/and DCI), or reported by the UE (e.g., the UE 116) (e.g. via CSI report over UCI or/and UE capability report). When reported by the UE, a CSI/UCI part 1 of a two-part CSI/UCI can be used/configured for reporting.
In one example, ν layers can be divided into G groups of layers, and the report quantity q corresponds to or associated with (or provides information about) quality of one of or a subset of or all of the group of layers, i.e., the indicator indicates one value for a group of layers or one value for each of a subset of or all of the group of layers. When there are multiple layers associated with (mapped to) a group of layers, the corresponding value applies to the multiple layers within the group. The mapping of layers to groups of layers can be fixed, or configured (e.g. via RRC or/and DCI) or reported by the UE (e.g. via CSI report over UCI or/and UE capability report). The number of value(s) included in the report quantity q can be fixed (e.g. 1 or ν or number of CWs), or configured (e.g. via RRC or/and DCI), or reported by the UE (e.g. via CSI report over UCI or/and UE capability report). When reported by the UE, a CSI/UCI part 1 of a two-part CSI/UCI can be used/configured for reporting.
In one example, when the report quantity q include multiple values, as described herein, the reporting of the multiple values can be absolute (i.e. separate/independent values) or relative (w.r.t. to reference). When relative, the reference index or/and value can be fixed, e.g. a first of the multiple index or/and values). In one example, when relative, the reference value can be fixed (e.g. to 1, and hence not reported) but the corresponding reference index is reported. In one example, when relative, the reference index can be fixed (e.g. to a first index, and hence not reported) but the corresponding reference value is reported.

In one example, a metric to quantify the strength/quality of the at least one layer, indicated by the report quantity q is according to at least one of the following examples.
In one example, the metric corresponds to an RSRP value. In one example, the RSRP values or/and payload (number of bits) for reporting is the same as that for L1-RSRP reporting in [REF 8] and [REF 7].
In one example, the metric corresponds to power (or square of amplitude) or amplitude value. In one example, the power/amplitude values or/and payload (number of bits) for reporting is the same as that for amplitude reporting in Rel-15 or Rel-16 Type II or enhanced Type II codebook as described in [REF 8] and [REF 7].
In one example, the metric corresponds to eigenvalues associated with the v “strongest” eigenvectors (with maximum values of eigenvalues) of the measured channel (e.g. DL channel measurement based on NZP CSI-RS). In one example, the eigenvalues or/and payload (number of bits) is the same as that for amplitude reporting in Rel-15 or Rel-16 Type II or enhanced Type II codebook as described in [REF 8] and [REF 7].
In one example, the metric corresponds to a CQI value. In one example, this CQI is in addition to the CQI reported via the CSI report (i.e. either one WB CQI, or one WB CQI+one SB CQI for each SB relative to the WB CQI). Besides, this CQI can be reported differentially relative to (w.r.t.) the WB CQI as reference. When there are multiple (e.g. 2) WB CQI (e.g. 1 WB CQI per CW, or 1 WB CQI for layer 1-4 and 1 WB CQI for layer 5 and above), this CQI can be reported differentially relative to the respective WB CQI, or a first of the multiple WB CQI. In one example, the number of bits for this CQI reporting can be the same as that for the WB CQI (i.e. 4 bits). In one example, the number of bits for this CQI reporting can be more than that for the WB CQI (e.g. for 5 or 6 bits for this CQI). In one example, the number of bits for this CQI reporting can be less than that for the WB CQI (e.g. for 1 or 2 or 3 bits for this CQI).
In one example, the metric corresponds to an MCS level/value.
In one example, the metric corresponds to a SINR level/value. In one example, the SINR values or/and payload (number of bits) for reporting is the same as that for L1-SINR reporting in [REF 8] and [REF 7].

In one example, when the report includes a CSI determined based on a Type II or enhanced Type II or further enhanced Type II codebooks or their extension to CJT and Doppler (e.g. 5.2.2.2.3/4/5/6/7/8/9/10/11 of [REF 8]), where the codebooks comprise a basis component (W1: SD, FD, DD vectors) and a coefficient component (W2: to combine/sum the basis vectors), a metric to quantify the strength/quality of the at least one layer, indicated by the report quantity q is according to at least one of the following examples.
In one example, the metric corresponds to or is associated with the coefficients (W2). For example, the metric can represent RSRP or power or amplitude or CQI or MCS or SINR value/level of the corresponding layer(s) (cf. according to one or more examples described herein).
   In one example, the metric corresponds to or is associated with coefficients of a layer. For example, 2LM_{ν} coefficients in case of Rel-16 enhanced Type II codebook.
   In one example, the metric corresponds to or is associated with non-zero (NZ) coefficients. In one example, the NZ coefficients for layer for layer l,

$${K}_{l}^{N Z} < 2 {LM}_{υ}$$

can be determined based on a parameter β that can be configured as in Rel-16 enhanced Type II codebook.
In one example, the metric corresponds to or is associated with the basis (W1). For example, the metric can represent RSRP or power or amplitude or CQI or MCS or SINR value/level of the corresponding layer(s) (cf. according to one or more examples described herein).
   In one example, the metric corresponds to or is associated with the L SD vectors.
   In one example, the metric corresponds to or is associated with the M_{ν} FD vectors.
   In one example, the metric corresponds to or is associated with the L SD vectors and the M_{ν} FD vectors.
   In one example, the metric corresponds to or is associated with the Q DD vectors.
   In one example, the metric corresponds to or is associated with the L SD vectors, the M_{ν} FD vectors, and the Q DD vectors.
In one example, the metric corresponds to or is associated with a strongest coefficient (SC) of the coefficients (W2). The SC can be one value and across coefficients of layers, or one value for each layer. The metric can represent RSRP or power or amplitude value/level of the SC, either one value for layers or one value for each layer. In one example, the SC indicator (SCI) is not reported when this metric is reported. In one example, the SC indicator (SCI) is reported regardless of whether this metric is reported or not. In one example, the SC indicator (SCI) is reported for layers for which this metric is not reported, and the SCI is not reported for layers for which this metric is reported.

In one example, a metric to quantify the strength/quality of the at least one layer, indicated by the report quantity q is based on a water-filling/water-pouring solution/scheme, wherein for each layer l, a power level/value pᵢ is determined such that

$${\sum }_{l = 1}^{υ} {p}_{l}^{2} = 1$$

and pᵢ∈[0,1]. In one example,

$${p}_{l} = \frac{1}{\sqrt{υ}}$$

as in the Type I or Type II codebooks. In one example, pₗ values are determined according to at least one of the following examples.
In one example, pₗ values are determined based on an eigenvalue associated with layer l.
In one example, pₗ values are determined based on raw (un-quantized) coefficients for layer l. Note that, Rel-16 enhanced Type IL, per-layer bitmap and coefficient amplitudes together can provide a some ‘coarse’ information about the report quantity q, however, due to a per layer SCI (normalization by the max value of the coefficient amplitudes), the absolute layer quality/strength can be recovered accurately.

In one example, the granularity of the reporting of the report quantity q is according to at least one of the following examples.
In one example, the granularity in FD is WB, i.e., one value or multiple values are reported, as described herein, and the reported value(s) is for the entire reporting band configured for the reporting. The resolution (number of bits) for this WB reporting can be fixed (e.g. 4 or 5 or 6 or 7bits), or configured from a candidate set of values, e.g. from {3, 4, . . . , 10}.
In one example, the granularity in FD is SB, i.e., one value or multiple values are reported, as described herein, for each SB in the reporting band configured for the reporting. That is, if number of SBs N_{SB}>1, then for each of N_{SB} SBs, one value or multiple values are reported, as described herein. This SB reporting can be independent/separate for each SB. Or it can be differential w.r.t. to a WB value. The number of bits for reporting WB and (differential) SB values can be N_{WB} and N_{SB} where N_{WB}>N_{SB}. In one example, N_{WB} and N_{SB} are fixed. In one example, N_{WB} is configured (e.g., according to one or more examples described herein), and N_{SB} is configured. In one example, N_{WB} is fixed (e.g., according to one or more examples described herein), and N_{SB} is fixed (e.g. 1 or 2 or 3 bits). In one example, N_{WB} and N_{SB} are configured (e.g., according to one or more examples described herein).

In one example, the reporting of the report quantity q can be a standalone report (i.e. not multiplexed with any other report or UCI parameter). In one example, the report can be a non-standalone report, hence can be multiplexed together with another report or UCI parameter. When multiplexed with another report or UCI parameter, the another report can be a CSI report and the UCI parameter can be at least one of RI, PMI, CQI, LI, CRI, SSB resource indicator (SSBRI), L1-RSRP, L1-SINR, and time-domain channel property (TDCP). In one example, the report can be standalone or non-standalone based on configuration (from the NW, e.g. RRC or/and MAC CE or/and DCI) or UE capability. In one example, the report can be a non-standalone report, and is a part of (included in) a CSI report, where the CSI report can include at least one of RI, PMI, CQI, LI, CRI.

In one example, the UE determines a CSI report, and additionally, determines the report including the report quantity q where the report quantity q is conditioned on the CSI report. The additional reporting of the report quantity q can be configurable (e.g. can be turned ON/OFF or disabled/enabled by the NW for example based on RRC or DCI or MAC CE based signaling) or optional (e.g. can be subject to UE capability). When turned ON or being capable of such reporting, the UE provides the report quantity q together with the CSI report. When turned OFF or incapable of such reporting, the UE only provides the CSI report (without the report quantity q).

In one example, the report quantity q (in the report as described herein) is determined/reported according to at least one of the following examples.
In one example, the report quantity q is determined/selected freely.
In one example, the report quantity q is determined/selected with a restriction. In one example, the restriction can be based on a configuration (e.g. RRC) or a component in the CSI report (e.g. CQI or PMI or RI).

In one example, the indicator indicating the report quantity q includes a layer indicator (LI) or layer quality indicator (LQI).
In one example, the LI or LQI is a 1-bit ‘hard’ indicator taking values {0,1} for one layer (e.g. strongest layer), where a bit value 0 indicates a value v0 and a bit value 1 indicates a value v1.
In one example, the LI or LQI is a Z-bit indicator taking 2^{z} values for one layer (e.g. strongest layer), where Z>1.
In one example, the indicator indicating the report quantity q includes LI/LQI (1-bit or Z-bit per one or more examples described herein) for one layer or for one group/subset of layers, and for remaining layers, indicates power/amplitude level from a set. In one example, the set can include or be a subset of {1, ½, ¼, ⅛, . . . }.
In one example, the LI or LQI is a 1-bit ‘hard’ indicator or Z-bit indicator for each layer of u layers.

In one example, the LI or LQI further indicates column(s)/layer(s) of the precoder matrix of the reported PMI that it corresponds to, where the column(s)/layer(s) corresponds to the codeword corresponding to the largest reported wideband CQI. If two wideband CQIs are reported and have equal value, the LI or LQI corresponds to layer(s) of the first codeword.

In one example, if the UE reports two PMIs, indicating two precoding matrices (P₁, P₂) with rank {ν₁, ν₂}, the first LI or LQI indicates which column(s)/layer(s) of the precoder matrix of the first reported PMI that it corresponds to, where the column(s)/layer(s) corresponds to the first νᵢ layers of the codeword corresponding to the largest reported wideband CQI, and the second LI or LQI indicates which column(s)/layer(s) of the precoder matrix of the second reported PMI that it corresponds to, where the column(s)/layer(s) corresponds to the last v2 layers of the codeword corresponding to the largest reported wideband CQI.
In one example, the UE reports a CRI associated to a NZP CSI-RS Resource Pair, and a rank combination {ν₁, ν₂}.
In one example, when the UE is configured with a CSI-ReportConfig with reportQuantity set to ‘cri-RI-LI-PMI-CQI’ and the corresponding NZP-CSI-RS-ResourceSet for channel measurement is configured with two Resource Groups and N Resource Pairs, the UE can report a CRI associated to a NZP CSI-RS Resource Pair from N pairs, and a rank combination {ν₁, ν₂}.

In one example, if the UE reports two PMIs, indicating two precoding matrices (P₁, P₂) with rank {ν₁, ν₂}, the LI/LCI indicates column(s)/layer(s) across aggregated precoding matrix [P₁ P₂] or [P₂ P₁] or

$$[ \begin{matrix}{P}_{1} & 0 \\ 0 & {P}_{2}\end{matrix} ] or [ \begin{matrix}{P}_{2} & 0 \\ 0 & {P}_{1}\end{matrix} ] .$$

In one example, if the UE reports two PMIs, indicating two precoding matrices (P₁, P₂) with rank {ν₁, ν₂}, the LI/LCI indicates
(A) a selection of one the two PMIs and
(B) column(s)/layer(s) of the precoding matrix of the selected PMI.

In one example, the payload (number of bits) of the reporting q is according to at least one of the following example.
In one example, the payload is [log₂ ν] bits.
In one example, the payload is ν bits, 1 bit per layer.
In one example, the payload is νB bits, B bits per layer.
In one example, the payload is B bits for one layer (e.g. the strongest).
In one example, the payload is for two groups/subsets: B₁+B₂ bits, Bᵢ for νᵢ layer(s) and

$$υ = {\sum }_{i = 1}^{2} {υ}_{i}$$

In one example, the mapping of layers to groups/subsets can be fixed, e.g. CW-layer mapping, or configured (e.g. via RRC or/and DCI), or reported (e.g. CSI report or/and UE capability report).
In one example, the payload is for G>1 groups/subsets: B₁+ . . . +B_{G} bits, Bᵢ for νᵢ layer(s) and

$$υ = {\sum }_{i = 1}^{G} {υ}_{i} .$$

In one example, the mapping of layers to groups/subsets can be fixed, e.g. CW-layer mapping, or configured (e.g. via RRC or/and DCI), or reported (e.g. CSI report or/and UE capability report).
In one example, the value of G can be fixed (e.g. 2 or v), configured (e.g. via RRC or/and DCI), or reported (e.g. CSI report or/and UE capability report).

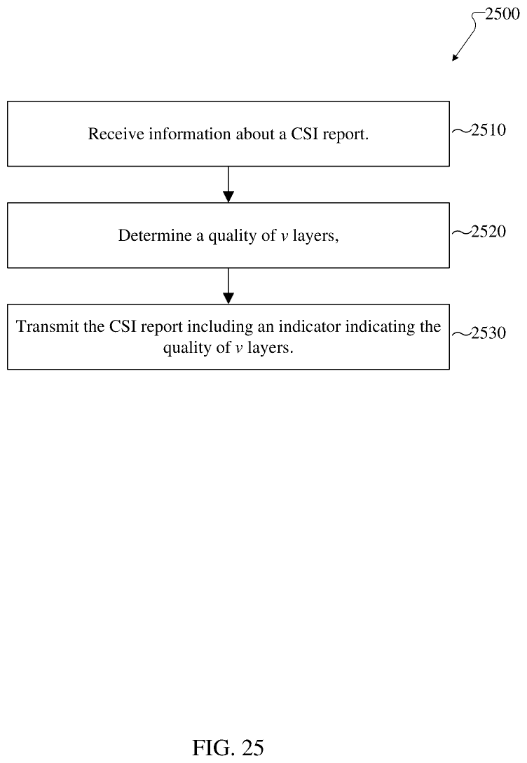

FIG. 25 illustrates an example method 2500 performed by a UE in a wireless communication system according to embodiments of the present disclosure. The method 2500 of FIG. 25 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 2500 is for illustration only and other embodiments can be used without departing from the scope of the present disclosure.

The method 2500 begins with the UE receiving information about a CSI report (2510). The UE then determines a quality of ν layers (2520). For example, in 2520, the determination is based on the received information and the number of layers, ν, is a positive integer.

The UE then transmits the CSI report including an indicator indicating the quality of v layers (2530). For example, in 2530, the quality of ν layers corresponds to q=[q₁, . . . , q_{ν}] where a value qₗ is associated with a layer l∈{1, . . . , ν} and qₗ≥0. In various embodiments, the value qₗ corresponds to a power or RSRP of the layer l. In various embodiments, the value qₗ corresponds to an eigenvalue of the layer l. In various embodiments, the value qₗ corresponds to a CQI of the layer l.

In various embodiments, the value qₗ=c_{ref}×dₗ in a linear scale or the value qₗ=c_{ref}+dₗ in a logarithmic scale, where c_{ref} is a reference value and dₗ is a differential value that is determined with respect to the reference value c_{ref}.

In various embodiments, when a number of subbands (SBs) for the CSI report N_{SB}>1, the value qₗ=[q_{l,1}, . . . q_{l,N}_{_{SB}}], where a value q_{l,k} is associated with the layer l and a SB k∈{1, . . . , N_{SB}}, and q_{l,k}≥0. In some examples, the value q_{l,k}=α_{ref}×b_{l,k} in a linear scale or the value q_{l,k}=α_{ref}+b_{l,k} in a logarithmic scale.

In one embodiment, the CSI report may include ranking information indicating ordering of layers based on quality. In one instance, CSI report may be limited to top-k layers. In another instance, the CSI report may be based on threshold, such that only layers with quality values above a predetermined threshold are reported.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to receive information about a channel state information (CSI) report; and
a processor operably coupled to the transceiver, the processor, based on the information, configured to determine a quality of ν layers, where ν≥1,
wherein the transceiver is further configured to transmit the CSI report including an indicator indicating the quality of ν layers, and
wherein the quality of ν layers corresponds to q=[q₁, . . . , q_{ν}], where a value qₗ is associated with a layer l∈{1, . . . , ν} and qₗ≥0.

2. The UE of claim 1, wherein the value qₗ corresponds to a power or reference signal receive power (RSRP) of the layer l.

3. The UE of claim 1, wherein the value qₗ corresponds to an eigenvalue of the layer l.

4. The UE of claim 1, wherein the value qₗ corresponds to a channel quality indicator (CQI) of the layer l.

5. The UE of claim 1, wherein:
the value qₗ=c_{ref}×dₗ in a linear scale, or
the value qₗ=c_{ref}+dₗ in a logarithmic scale,
where c_{ref} is a reference value and dₗ is a differential value that is determined with respect to the reference value c_{ref}.

6. The UE of claim 1, wherein, when a number of subbands (SBs) for the CSI report N_{SB}>1, the value qₗ=[q_{l,1}, . . . , q_{l,N}_{_{SB}}], where a value q_{l,k} is associated with the layer l and a SB k∈{1, . . . , N_{SB}}, and q_{l,k}≥0.

7. The UE of claim 6, wherein:
the value q_{l,k}=α_{ref}×b_{l,k} in a linear scale, or
the value q_{l,k}=α_{ref}+b_{l,k} in a logarithmic scale,
where are is a reference value and b_{l,k} is a differential value that is determined with respect to the reference value α_{ref}.

8. A base station (BS), comprising:
a processor; and
a transceiver operably coupled to the processor, the transceiver configured to:
transmit information about a channel state information (CSI) report; and
receive the CSI report including an indicator indicating a quality of ν layers, where ν≥1,
wherein the quality of ν layers corresponds to q=[q₁, . . . , q_{ν}], where a value qₗ is associated with a layer l∈{1, . . . , ν} and qₗ≥0.

9. The BS of claim 8, wherein the value qₗ corresponds to a power or reference signal receive power (RSRP) of the layer l.

10. The BS of claim 8, wherein the value qᵢ corresponds to an eigenvalue of the layer l.

11. The BS of claim 8, wherein the value qᵢ corresponds to a channel quality indicator (CQI) of the layer l.

12. The BS of claim 8, wherein:
the value qₗ=c_{ref}×dₗ in a linear scale, or
the value qₗ=c_{ref}+dₗ in a logarithmic scale,
where c_{ref} is a reference value and dₗ is a differential value that is determined with respect to the reference value c_{ref}.

13. The BS of claim 8, wherein, when a number of subbands (SBs) for the CSI report N_{SB}>1, the value qₗ=[q_{l,1}, . . . , q_{l,N}_{_{SB}}], where a value q_{l,k} is associated with the layer l and a SB k∈{1, . . . , N_{SB}}, and q_{l,k}≥0.

14. The BS of claim 13, wherein:
the value q_{l,k}=α_{ref}×b_{l,k} in a linear scale, or
the value q_{l,k}=α_{ref}+b_{l,k} in a logarithmic scale,
where α_{ref} is a reference value and b_{l,k} is a differential value that is determined with respect to the reference value α_{ref}.

15. A method performed by a user equipment (UE), the method comprising:
receiving information about a channel state information (CSI) report;
determining, based on the information, a quality of ν layers, where ν≥1; and
transmitting the CSI report including an indicator indicating the quality of ν layers,
wherein the quality of ν layers corresponds to q=[q₁, . . . , q_{ν}], where a value qₗ is associated with a layer l∈{1, . . . , ν} and qₗ≥0.

16. The method of claim 15, wherein the value qₗ corresponds to a power or reference signal receive power (RSRP) of the layer l.

17. The method of claim 15, wherein the value qₗ corresponds to an eigenvalue of the layer l.

18. The method of claim 15, wherein the value qₗ corresponds to a channel quality indicator (CQI) of the layer l.

19. The method of claim 15, wherein:
the value qₗ=c_{ref}×dₗ in a linear scale, or
the value qₗ=c_{ref}+dₗ in a logarithmic scale,
where c_{ref} is a reference value and dₗ is a differential value that is determined with respect to the reference value c_{ref}.

20. The method of claim 15, wherein, when a number of subbands (SBs) for the CSI report N_{SB}>1, the value qₗ=[q_{l,1}, . . . , q_{l,N}_{_{SB}}], where a value q_{l,k} is associated with the layer l and a SB k∈{1, . . . , N_{SB}}, and q_{l,k}≥0.
